(19) United States
(12) Patent Application Publication
(10) Pub. No.: US 2016/0048728 A1
(43) Pub. Date: Feb. 18, 2016

(54) METHOD AND SYSTEM FOR OPTICAL CHARACTER RECOGNITION THAT SHORT CIRCUIT PROCESSING FOR NON-CHARACTER CONTAINING CANDIDATE SYMBOL IMAGES

(71) Applicant: ABBYY Development LLC, Moscow (RU)

(72) Inventor: Yuri Chulinin, Moscow (RU)

(21) Appl. No.: 14/568,814

(22) Filed: Dec. 12, 2014

(30) Foreign Application Priority Data
Aug. 12, 2014 (RU) 2014133070

(51) Int. Cl. G06K 9/00

(52) U.S. Cl. CPC G06K 9/00442; G06K 2209/011; G06K 2209/013

(57) ABSTRACT

The current document is directed to methods and systems for identifying Chinese, Japanese, Korean, or similar language symbols that correspond to symbol images in a scanned-document image or other text-containing image. In a first processing phase, each symbol image is associated with a set of candidate graphemes. In a second processing phase, each symbol image is evaluated with respect to the set of candidate graphemes identified for the symbol image during the first phase. As candidate graphemes are processed, the currently described methods and systems monitor progress towards identifying a matching grapheme and, when insufficient progress is observed, terminate processing of the candidate graphemes and identify the symbol image as a non-symbol-containing area of the scanned-document image or other text-containing image.

### CROSS REFERENCE TO RELATED APPLICATIONS

This application claims the benefit of priority to Russian Patent Application No. 2014133070, filed Aug. 12, 2014; disclosure of which is incorporated herein by reference in its entirety.

### TECHNICAL FIELD

The current document is directed to automated processing of scanned-document images and other text-containing images and, in particular, to methods and systems that efficiently convert symbol images to digital encodings of the corresponding symbols and that recognize, early in the conversion process, non-character-containing symbol images and terminate the conversion process for non-character-containing symbol images.

### BACKGROUND

Printed, typewritten, and handwritten documents have long been used for recording and storing information. Despite current trends towards paperless offices, printed documents continue to be widely used in commercial, institutional, and home environments. With the development of modern computer systems, the creation, storage, retrieval, and transmission of electronic documents has evolved, in parallel with continued use of printed documents, into an extremely efficient and cost-effective alternative information-recording and information-storage medium. Because of overwhelming advantages in efficiency and cost effectiveness enjoyed by modern electronic-document-based information storage and information transactions, printed documents are routinely converted into electronic documents by various methods and systems, including conversion of printed documents into digital scanned-document images using electro-optico-mechanical scanning devices, digital cameras, and other devices and systems followed by automated processing of the scanned-document images to produce electronic documents encoded according to one or more of various different electronic-document-encoding standards. As one example, it is now possible to employ a desktop scanner and sophisticated optical-character-recognition (“OCR”) control programs that control a personal computer to convert a printed-paper document into a corresponding electronic document that can be displayed and edited using a word-processing program.

While modern OCR systems have advanced to the point that complex printed documents that include pictures, frames, line boundaries, and other non-text elements as well as text symbols of any of many common alphabet-based languages can be automatically converted to electronic documents, challenges remain with respect to conversion of printed documents containing Chinese and Japanese characters or Korean morpho-syllabic blocks.

### SUMMARY

The current document is directed to methods and systems for identifying Chinese, Japanese, Korean, or similar language symbols that correspond to symbol images in a scanned-document image or other text-containing image. In a first processing phase, each symbol image is associated with a set of candidate graphemes. In a second processing phase, each symbol image is evaluated with respect to the set of candidate graphemes identified for the symbol image during the first phase. As the candidate graphemes are processed, the currently described methods and systems monitor progress towards identifying a matching grapheme and, when insufficient progress is observed, terminate processing of the candidate graphemes and identify the symbol image as a non-symbol-containing area of the scanned-document image or other text-containing image.

### BRIEF DESCRIPTION OF THE DRAWINGS

FIG. 1A illustrates a printed document.

FIG. 1B illustrates a printed document.

FIG. 2 illustrates a typical desktop scanner and personal computer that are together used to convert printed documents into digitally encoded electronic documents stored in mass-storage devices and/or electronic memories.

FIG. 3 illustrates operation of the optical components of the desktop scanner shown in FIG. 2.

FIG. 4 provides a general architectural diagram for various types of computers and other processor-controlled devices.

FIG. 5 illustrates digital representation of a scanned document.

FIG. 6 shows a hypothetical symbol set.

FIG. 7A illustrates various aspects of symbol sets for natural languages.

FIG. 7B illustrates various aspects of symbol sets of natural languages.

FIG. 7C illustrates various aspects of symbol sets of natural languages.

FIG. 8A illustrates parameters and parameter values computed with respect to symbol images.

FIG. 8B illustrates parameters and parameter values computed with respect to symbol images.

FIG. 9 shows a table of parameter values computed for all of the symbols in the example symbol set shown in FIG. 6.

FIG. 10 illustrates a three-dimensional plot of the symbols of the example set of symbols shown in FIG. 6 within a three-dimensional space, where the dimensions represent values of each of three different parameters.

FIG. 11A shows the symbols contained in each of the clusters represented by points in the three-dimensional space shown in FIG. 10.

FIG. 11B shows the symbols contained in each of the clusters represented by points in the three-dimensional space shown in FIG. 10.

FIG. 12A illustrates a different parameter that can be used, in combination with the three parameters corresponding to dimensions in the three-dimensional parameter space shown in FIG. 10, to fully distinguish each of the symbols in cluster 8.

FIG. 12B illustrates the value of the additional parameter, discussed with reference to FIG. 12A, for each of the symbols in cluster 8.

FIG. 13 illustrates a small text-containing image that has been initially processed, by an OCR system, to produce a grid of symbol windows 1300, each containing a symbol image.

FIG. 14 illustrates a general approach to processing of the grid of symbol windows, shown in FIG. 13.

FIG. 15 illustrates a first approach to implementing the routine “process” (1404 in FIG. 14).

FIG. 16A illustrates a second implementation of the routine “process” (1404 in FIG. 14).

FIG. 16B illustrates a second implementation of the routine “process” (1404 in FIG. 14).

FIG. 17 illustrates a third implementation of the routine “process,” discussed in the previous subsection, using the same illustration and pseudocode conventions used in the previous subsection.

FIG. 18 illustrates data structures that provide for clustering and preprocessing in one implementation of an OCR system that incorporates the general third implementation or the routine “process,” described above.

FIG. 19A illustrates preprocessing of a symbol image using the data structures discussed above with reference to FIG. 18.

FIG. 19B illustrates preprocessing of a symbol image using the data structures discussed above with reference to FIG. 18.

FIG. 19C illustrates preprocessing of a symbol image using the data structures discussed above with reference to FIG. 18.

FIG. 19D illustrates preprocessing of a symbol image using the data structures discussed above with reference to FIG. 18.

FIG. 19E illustrates preprocessing of a symbol image using the data structures discussed above with reference to FIG. 18.

FIG. 20A illustrates multi-cluster OCR-based symbol-image-containing document processing.

FIG. 20B illustrates multi-cluster OCR-based symbol-image-containing document processing.

FIG. 20C illustrates multi-cluster OCR-based symbol-image-containing document processing.

FIG. 20D illustrates multi-cluster OCR-based symbol-image-containing document processing.

FIG. 20E illustrates multi-cluster OCR-based symbol-image-containing document processing.

FIG. 20F illustrates multi-cluster OCR-based symbol-image-containing document processing.

FIG. 20G multi-cluster OCR-based symbol-image-containing document processing.

FIG. 21 illustrates a second phase of the OCR methods that associate symbol codes with symbol images.

FIG. 22 illustrates one approach to parallelizing second-phase processing of symbol images with respect to candidate graphemes.

FIG. 23A illustrates parallelizing processing of an individual symbol image with respect to the candidate graphemes identified for the symbol image.

FIG. 23B illustrates parallelizing processing of an individual image.

FIG. 24 illustrates some example image-based-matching methods.

FIG. 25 illustrates a problem that may be encountered in scanned-document-image processing.

FIG. 26 illustrates a generalized comparison function that compares a symbol image to a candidate grapheme and that is used during second-phase scanned-document-image processing to evaluate the candidate graphemes associated with each symbol image in the processed symbol image table.

FIG. 27A illustrates progress-to-recognition curves for symbol-image-to-symbol-code conversion by an OCR method and system.

FIG. 27B illustrates progress-to-recognition curves for symbol-image-to-symbol-code conversion by an OCR method and system.

FIG. 28A illustrates various implementations of a cutoff function that determines when to terminate processing in order to improve processing efficiency and avoid the potential disadvantages of processing a non-symbol-containing symbol image.

FIG. 28B illustrates various implementations of a cutoff function that determines when to terminate processing in order to improve processing efficiency and avoid the potential disadvantages of processing a non-symbol-containing symbol image.

FIG. 28C illustrates various implementations of a cutoff function that determines when to terminate processing in order to improve processing efficiency and avoid the potential disadvantages of processing a non-symbol-containing symbol image.

FIG. 28D illustrates various implementations of a cutoff function that determines when to terminate processing in order to improve processing efficiency and avoid the potential disadvantages of processing a non-symbol-containing symbol image.

FIG. 29A provides control-flow diagrams that illustrate use of a cutoff function, during the second phase of scanned-document-image processing, to terminate symbol-image processing prior to evaluation of all of the candidate graphemes associated with a symbol image.

FIG. 29B provides control-flow diagrams that illustrate use of a cutoff function, during the second phase of scanned-document-image processing, to terminate symbol-image processing prior to evaluation of all of the candidate graphemes associated with a symbol image.

FIG. 30A illustrates various different types of cutoff strategies.

FIG. 30B illustrates various different types of cutoff strategies.

FIG. 30C illustrates various different types of cutoff strategies.

FIG. 31 illustrates an approach to second-phase processing suitable for implementations in which composite graphemes may be used for symbol-image recognition.

### DETAILED DESCRIPTION

The current document is directed to methods and systems for identifying symbols corresponding to symbol images in a scanned-document image. In one implementation, the methods and systems to which the current document is directed carry out an initial processing step on one or more scanned images to identify a set of candidate graphemes for individual symbol images in the scanned document. In a second phase, the symbol images are evaluated with respect to the candidate graphemes. In certain cases, a symbol image may have been incorrectly identified in the first phase of document processing, as a result of which the purported symbol image does not contain the image of a symbol. Were all the candidate graphemes associated with such a symbol evaluated, significant computational overheads would be incurred without providing any benefit to document processing. The current document describes methods that allow second-phase processing of a symbol image to be short circuited, as soon as a determination can be made that the image does not include a symbol image.

The following discussion is divided in two parts. In a first subsection, document scanning and computer architecture are reviewed. In a second subsection, optical character recognition is discussed, and are reviewed, along with a detailed description of the first phase of document processing, in which candidate graphemes are identified for, and associated with, symbol images. In a third subsection, early recognition of non-symbol-containing symbol images and short-circuiting of second-phase processing for non-symbol-containing symbol images is discussed.

### Scanned Document Images and Electronic Documents

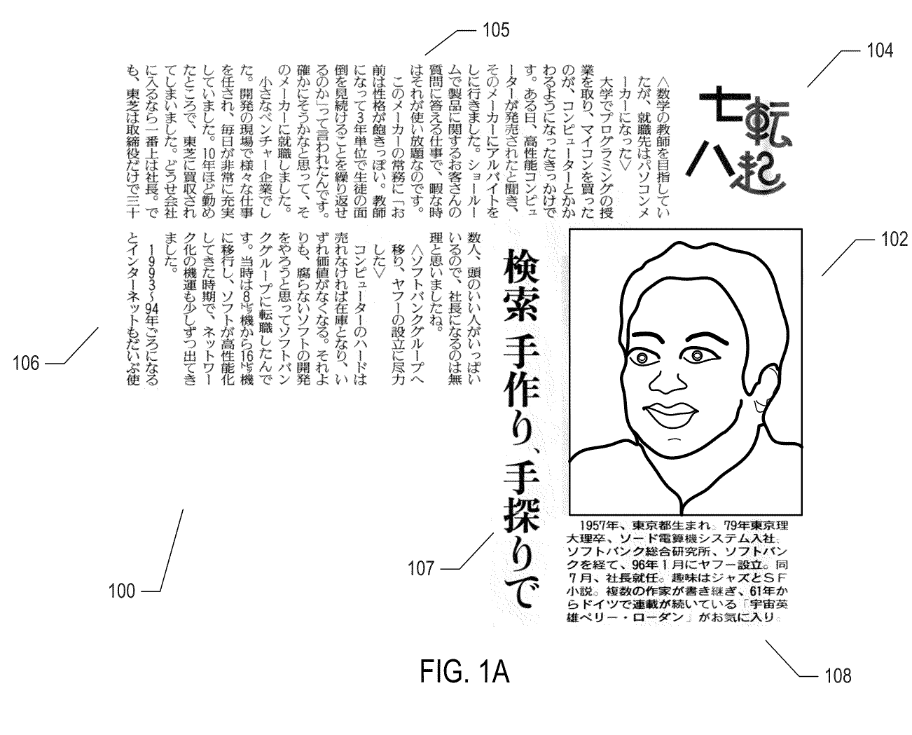

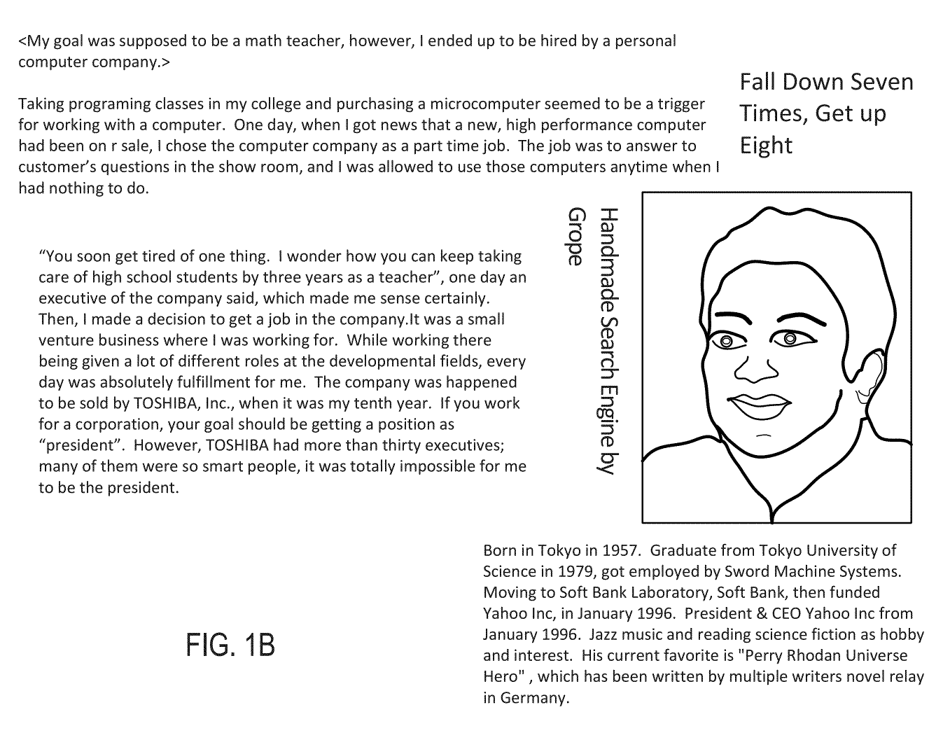

FIGS. 1A-B illustrates a printed document. FIG. 1A shows the original document with Japanese text. The printed document 100 includes a photograph 102 and five different text-containing regions 104-108 that include Japanese characters. This is an example document used in the following discussion of the method and systems for sense-orientation determination to which the current application is directed. The Japanese text may be written in left-to-right fashion, along horizontal rows, as English is written, but may alternatively be written in top-down fashion within vertical columns. For example, region 107 is clearly written vertically while text block 108 includes text written in horizontal rows. FIG. 1B shows the printed document illustrated in FIG. 1A translated into English.

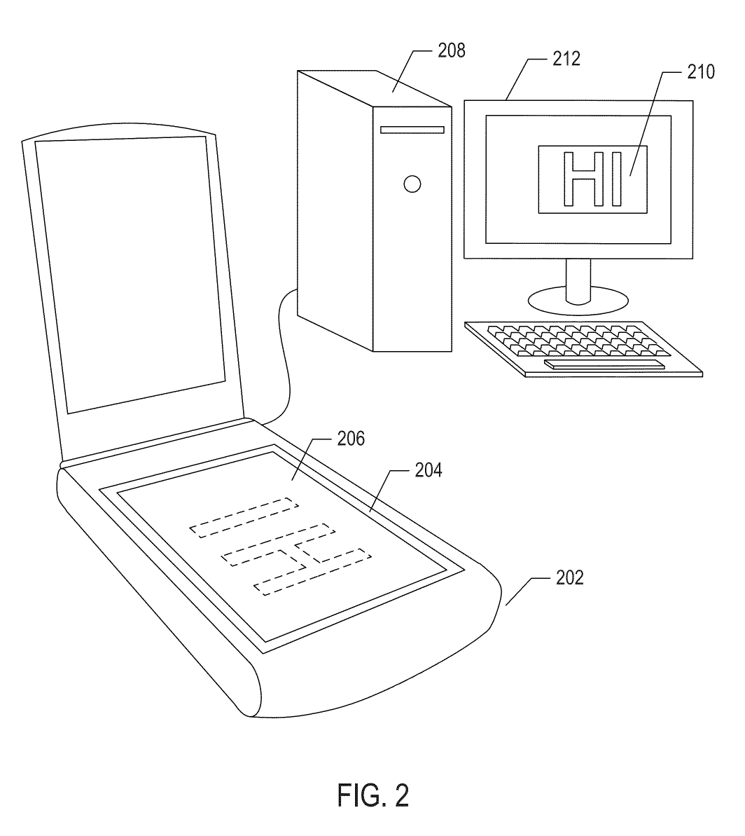

Printed documents can be converted into digitally encoded, scanned-document images by various means, including electro-optico-mechanical scanning devices and digital cameras. FIG. 2 illustrates a typical desktop scanner and personal computer that are together used to convert printed documents into digitally encoded electronic documents stored in mass-storage devices and/or electronic memories. The desktop scanning device 202 includes a transparent glass bed 204 onto which a document is placed, face down 206. Activation of the scanner produces a digitally encoded scanned-document image which may be transmitted to the personal computer (“PC”) 208 for storage in a mass-storage device. A scanned-document-image-rendering program may render the digitally encoded scanned-document image for display 210 on a PC display device 212.

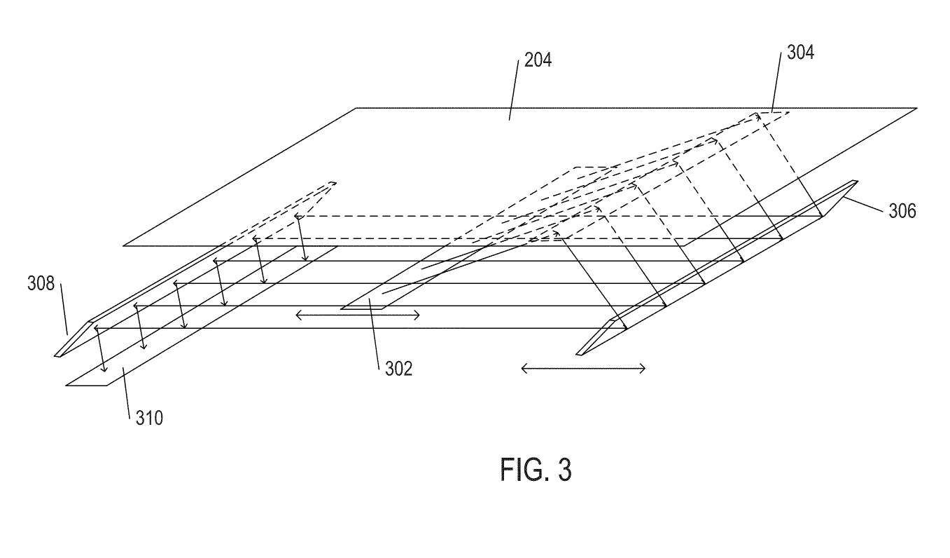

FIG. 3 illustrates operation of the optical components of the desktop scanner shown in FIG. 2. The optical components in this charge-coupled-device (“CCD”) scanner reside below the transparent glass bed 204. A laterally translatable bright-light source 302 illuminates a portion of the document being scanned 304 which, in turn, re-emits and reflects light downward. The re-emitted and reflected light is reflected by a laterally translatable mirror 306 to a stationary mirror 308, which reflects the emitted light onto an array of CCD elements 310 that generate electrical signals proportional to the intensity of the light falling on each of the CCD elements. Color scanners may include three separate rows or arrays of CCD elements with red, green, and blue filters. The laterally translatable bright-light source and laterally translatable mirror move together along a document to produce a scanned-document image. Another type of scanner is referred to as a “contact-image-sensor scanner” (“CIS scanner”). In a CIS scanner, moving colored light-emitting diodes (“LEDs”) provide document illumination, with light reflected from the LEDs sensed by a photodiode array that moves together with the colored light-emitting diodes.

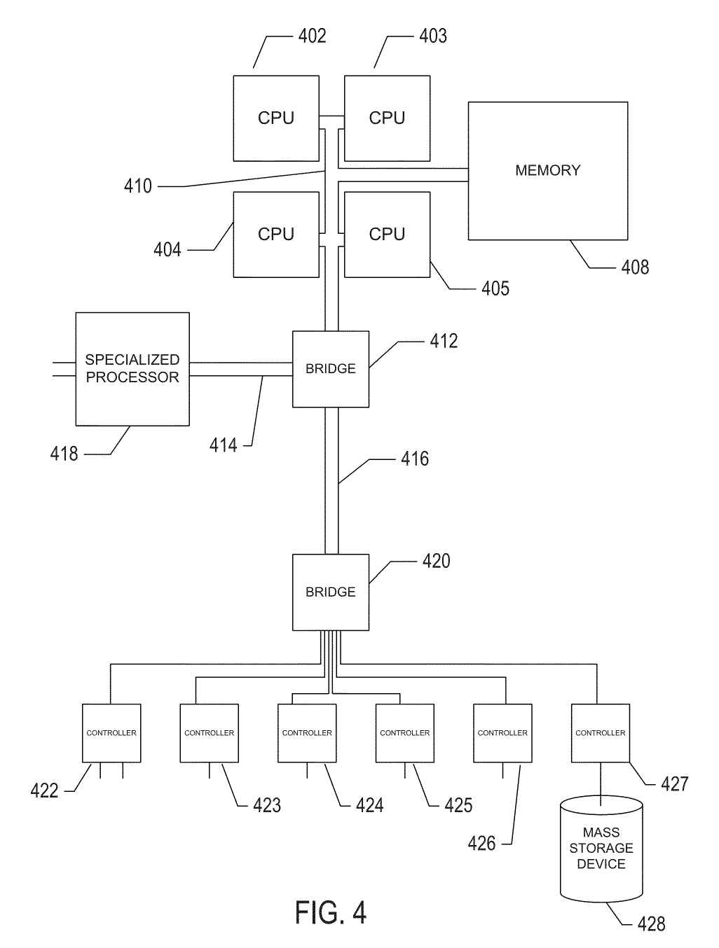

FIG. 4 provides a general architectural diagram for various types of computers and other processor-controlled devices. The high-level architectural diagram may describe a modern computer system, such as the PC in FIG. 2, in which scanned-document-image-rendering programs and optical-character-recognition programs are stored in mass-storage devices for transfer to electronic memory and execution by one or more processors to transform the computer system into a specialized optical-character-recognition system. The computer system contains one or multiple central processing units (“CPUs”) 402-405, one or more electronic memories 408 interconnected with the CPUs by a CPU/memory-subsystem bus 410 or multiple busses, a first bridge 412 that interconnects the CPU/memory-subsystem bus 410 with additional busses 414 and 416, or other types of high-speed interconnection media, including multiple, high-speed serial interconnects. These busses or serial interconnections, in turn, connect the CPUs and memory with specialized processors, such as a graphics processor 418, and with one or more additional bridges 420, which are interconnected with high-speed serial links or with multiple controllers 422-427, such as controller 427, that provide access to various different types of mass-storage devices 428, electronic displays, input devices, and other such components, subcomponents, and computational resources.

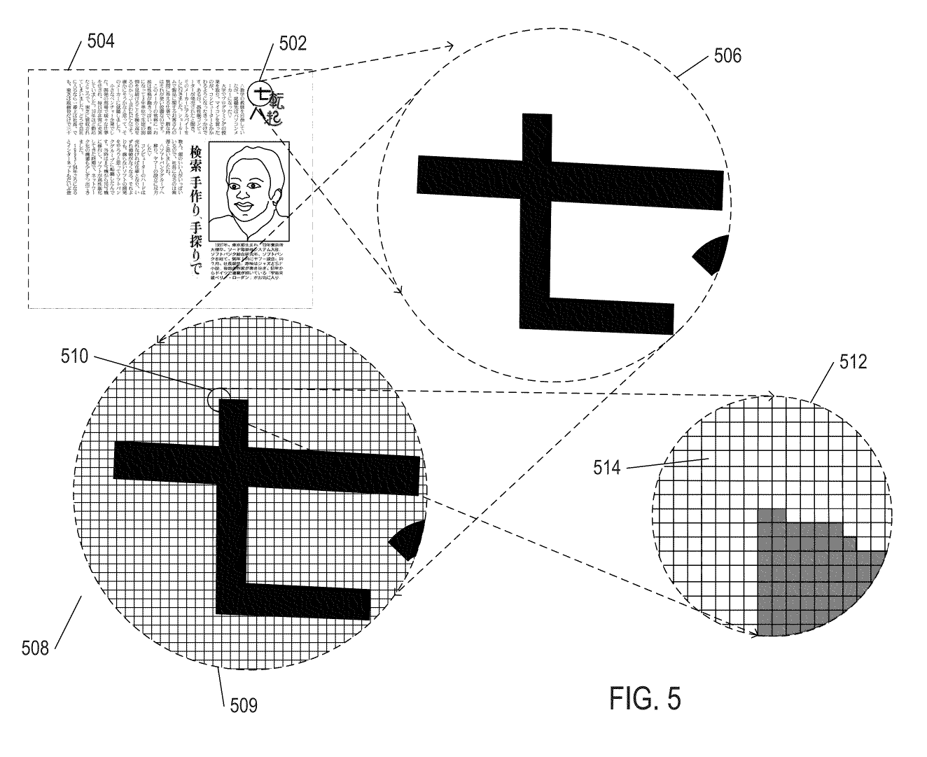

FIG. 5 illustrates digital representation of a scanned document. In FIG. 5, a small disk-shaped portion 502 of the example printed document 504 is shown magnified 506. A corresponding portion of the digitally encoded scanned-document image 508 is also represented in FIG. 5. The digitally encoded scanned document includes data that represents a two-dimensional array of pixel-value encodings. In the representation 508, each cell of a grid below the characters, such as cell 509, represents a square matrix of pixels. A small portion 510 of the grid is shown at even higher magnification, 512 in FIG. 5, at which magnification the individual pixels are represented as matrix elements, such as matrix element 514. At this level of magnification, the edges of the characters appear jagged, since the pixel is the smallest granularity element that can be controlled to emit specified intensities of light. In a digitally encoded scanned-document file, each pixel is represented by a fixed number of bits, with the pixel encodings arranged sequentially. Header information included in the file indicates the type of pixel encoding, dimensions of the scanned image, and other information that allows a digitally encoded scanned-document-image rendering program to extract the pixel encodings and issue commands to a display device or printer to reproduce the pixel encodings in a two-dimensional representation of the original document. Scanned-document images digitally encoded in monochromatic grayscale commonly use 8-bit or 16-bit pixel encodings, while color scanned-document images may use 24 bits or more to encode each pixel according to various different color-encoding standards. As one example, the commonly used RGB standard employs three 8-bit values encoded within a 24-bit value to represent the intensity of red, green, and blue light. Thus, a digitally encoded scanned image generally represents a document in the same fashion that visual scenes are represented in digital photographs. Pixel encodings represent light intensity in particular, tiny regions of the image and, for colored images, additionally represent a color. There is no indication, in a digitally encoded scanned-document image, of the meaning of the pixels encodings, such as indications that a small two-dimensional area of contiguous pixels represents a text character. Sub-images corresponding to symbol images can be processed to produce a bit for the symbol image, in which bits with value “1” correspond to the symbol image and bits with value “0” correspond to background. Bit maps are convenient for representing both extracted symbol images as well as patterns used by an OCR system to recognize particular symbols.

By contrast, a typical electronic document produced by a word-processing program contains various types of line-drawing commands, references to image representations, such as digitally encoded photographs, and digitally encoded text characters. One commonly used encoding standard for text characters is the Unicode standard. The Unicode standard commonly uses 8-bit bytes for encoding American Standard Code for Information Exchange (“ASCII”) characters and 16-bit words for encoding symbols and characters of many languages, including Japanese, Mandarin, and other non-alphabetic-character-based languages. A large part of the computational work carried out by an OCR program is to recognize images of text characters in a digitally encoded scanned-document image and convert the images of characters into corresponding Unicode encodings. Clearly, encoding text characters in Unicode takes far less storage space than storing pixilated images of text characters. Furthermore, Unicode-encoded text characters can be edited, reformatted into different fonts, and processed in many additional ways by word-processing programs while digitally encoded scanned-document images can only be modified through specialized image-editing programs.

In an initial phase of scanned-document-image-to-electronic-document conversion, a printed document, such as the example document 100 shown in FIG. 1, is analyzed to determine various different regions within the document. In many cases, the regions may be logically ordered as a hierarchical acyclic tree, with the root of the tree representing the document as a whole, intermediate nodes of the tree representing regions containing smaller regions, and leaf nodes representing the smallest identified regions. The tree representing the document includes a root node corresponding to the document as a whole and six leaf nodes each corresponding to one of the identified regions. The regions can be identified using a variety of different techniques, including many different types of statistical analyses of the distributions of pixel encodings, or pixel values, over the area of the image. For example, in a color document, a photograph may exhibit a larger variation in color over the area of the photograph as well as higher-frequency variations in pixel-intensity values than regions containing text.

Once an initial phase of analysis has determined the various different regions of a scanned-document image, those regions likely to contain text are further processed by OCR routines in order to identify text characters and convert the text characters into Unicode or some other character-encoding standard. In order for the OCR routines to process text-containing regions, an initial orientation of the text-containing region is determined so that various pattern-matching methods can be efficiently employed by the OCR routines to identify text characters. It should be noted that the images of documents may not be properly aligned within scanned-document images due to positioning of the document on a scanner or other image-generating device, due to non-standard orientations of text-containing regions within a document, and for other reasons. The text-containing regions are then partitioned into sub-images that contain individual characters or symbols, and these sub-images are then generally scaled and oriented, and the symbol images are centered within the sub-image to facilitate subsequent automated recognition of the symbols that correspond to the symbol images.

### Example OCR Methods and Systems

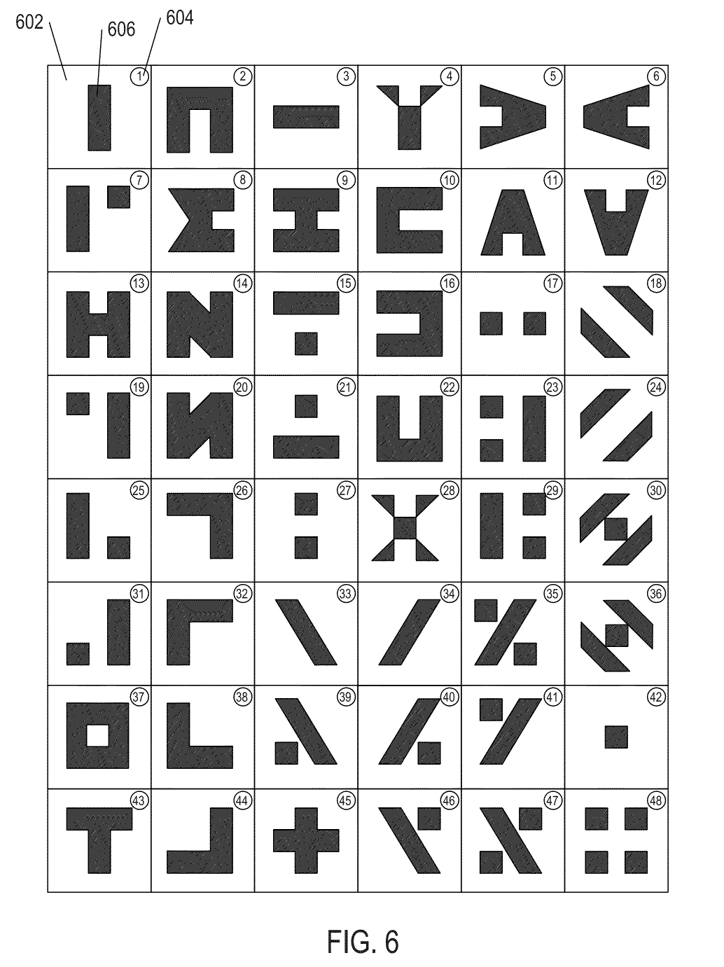

In order to provide a concrete discussion of various optical-character-recognition techniques, an example symbol set for a hypothetical language is used. FIG. 6 shows a hypothetical symbol set. In FIG. 6, 48 different symbols are shown within each of 48 rectangular regions, such as rectangular region 602. In the right-hard corner of each rectangular region, a numerical index or code for the symbol is shown inscribed within a circle, such as the index or code “1” 604 corresponding to the first symbol 606 shown in rectangular region 602. The example is chosen for illustration of both currently existing OCR methods and systems as well as new OCR methods and systems disclosed in the current document. In fact, for character-based written languages, including Chinese and Japanese, there may be many tens of thousands of different symbols used for printing and writing the language.

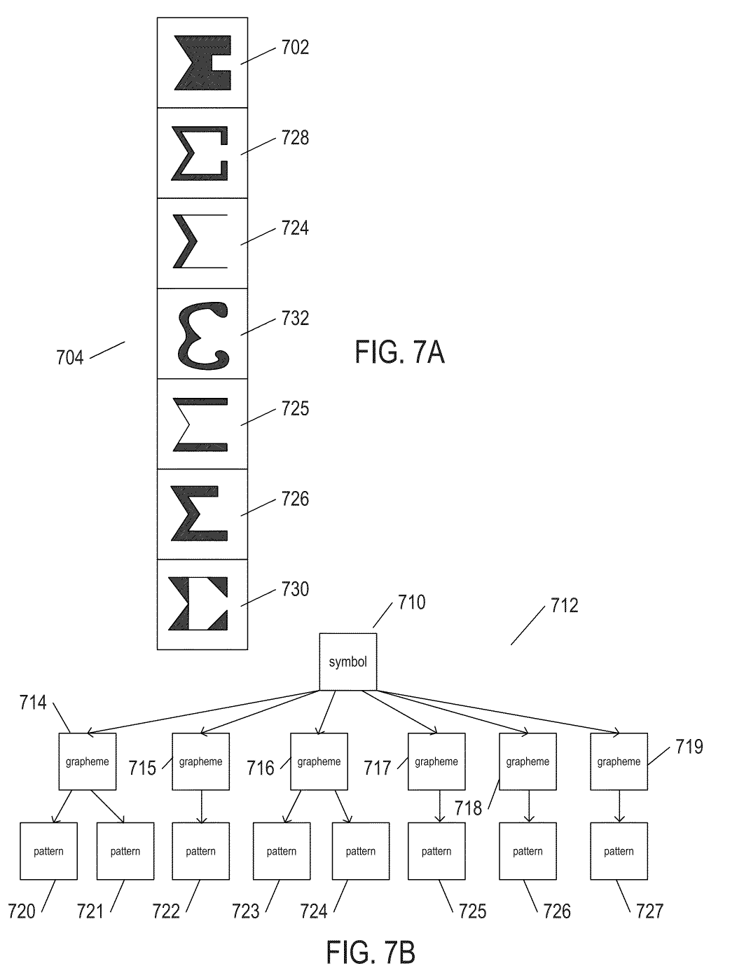

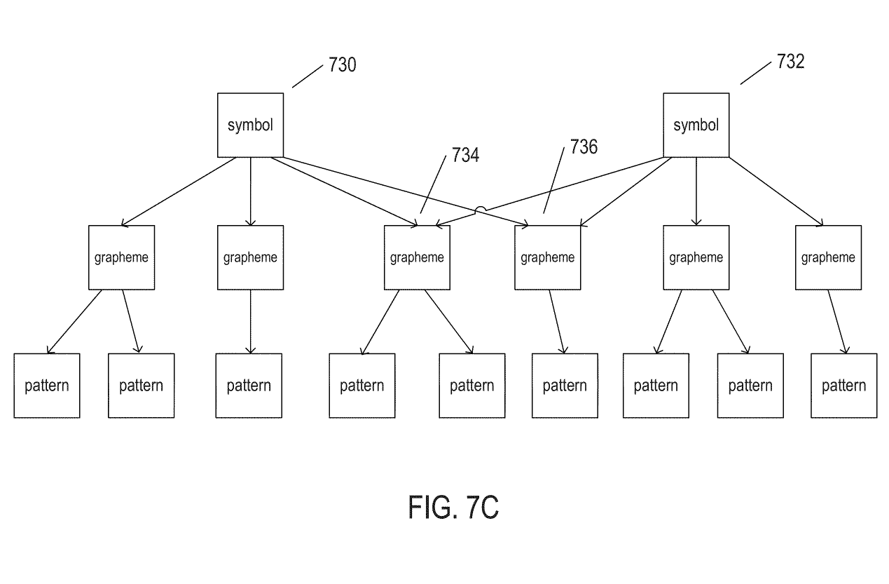

FIGS. 7A-B illustrate various aspects of symbol sets for natural languages. In FIG. 7A, a column of different forms of the eighth symbol in the symbol set shown in FIG. 6 is provided. The eighth symbol 702 of the symbol set shown in FIG. 6 is followed, in a column 704, by different forms of the symbol in different styles of text. In many natural languages, there may be many different text styles and alternative written forms for a given symbol.

FIG. 7B shows various different concepts related to symbols of a natural language. In FIG. 7B, a particular symbol of a natural language is represented by node 710 in graph 712. A particular symbol may have numerous different general written or printed forms. For OCR purposes, each of these different general forms constitutes a grapheme. In certain cases, a particular symbol may comprise two or more graphemes. For example, Chinese characters may comprise a combination of two or more graphemes, each of which occurs in additional characters. The Korean language is actually alphabetic, with Korean morpho-syllabic blocks containing a number of alphabetic characters in different positions. Thus, a Korean morpho-syllabic block may represent a higher-level symbol composed of multiple grapheme components. For symbol 710 shown in FIG. 7B, there are six different graphemes 714-719. There are, in addition, one or more different printed or written renderings of a grapheme, each rendering represented by a pattern. In FIG. 7B, graphemes 714 and 716 each has two alternative renderings represented by patterns 720 and 721 and 723-724, respectively. Graphemes 715 and 717-719 are each associated with a single pattern, patterns 722 and 725-727, respectively. For example, the eighth symbol of the example symbol set, shown in FIG. 6, may be associated with three graphemes, including one grapheme that encompasses renderings 702, 724, 725, and 726, a second grapheme that encompasses renderings 728 and 730, and a third grapheme that encompasses rendering 732. In this case, the first grapheme has straight horizontal members, the second grapheme has horizontal members with right-hand, short vertical members, and the third grapheme includes curved, rather than straight, features. Alternatively, all of the renderings of the eighth symbol 702, 728, 724, 732, 725, 726, and 730 may be represented as patterns associated with a single grapheme for the eighth symbol. To a certain extent, the choice of graphemes is somewhat arbitrary. In certain types of character-based languages, there may be many thousands of different graphemes. Patterns can be thought of as alternative renderings or images, and may be represented by a set of parameter/parameter-value pairs, as discussed below.

In fact, although the relationships between symbols, graphemes, and patterns is shown, in FIG. 7B, as being strictly hierarchical, with each grapheme related to a single, particular parent symbol, the actual relationships may not be so simply structured. FIG. 7C illustrates a slightly more complex set of relationships, in which two symbols 730 and 732 are both parents of two different graphemes 734 and 736. As one example, the English-language symbols “o,” the lower-case letter, “O,” the upper-case letter, “0,” the digit zero, and “°”, the symbol for degree, may all be associated with a circle-like grapheme. The relationships might alternatively be represented as graphs or networks. In certain cases, graphemes, rather than, or in addition to, symbols might be shown at the highest levels within the representation. In essence, there is a significant degree of arbitrariness in the symbols, graphemes, and patterns identified for a particular language and the relationships between them.

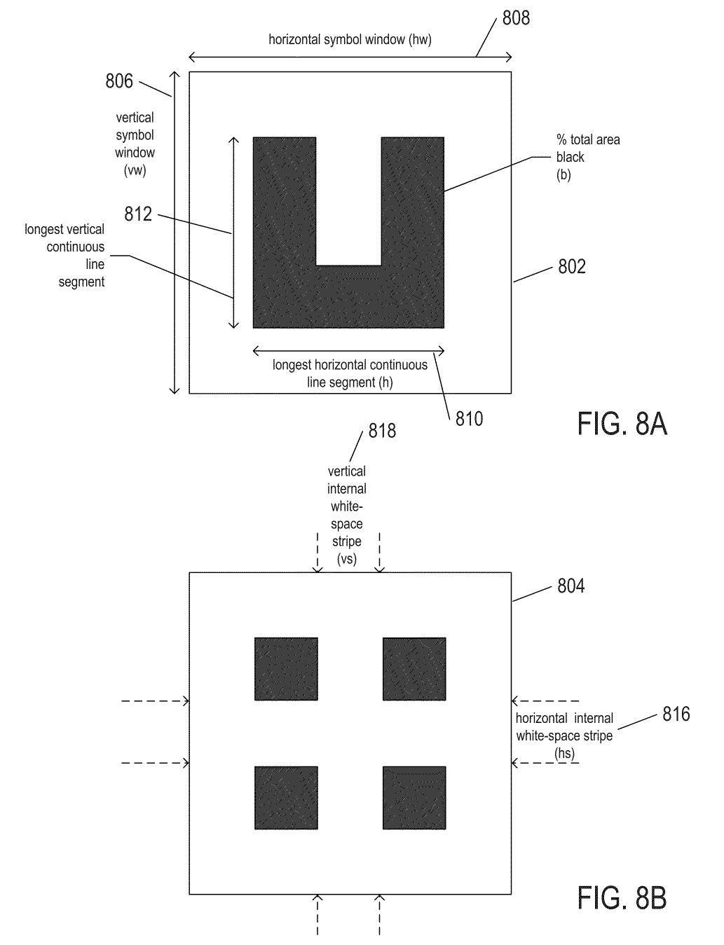

FIGS. 8A-B illustrate parameters and parameter values computed with respect to symbol images. Note that the phrase “symbol image” may describe a printed, written, or displayed rendering of a symbol or grapheme. In the following example, parameters and parameter values are discussed with respect to images of symbols, but, in an actual real-language context, the parameters and parameter values are often used to characterize and represent images of graphemes. FIG. 8A shows a rectangular symbol image 802 extracted from a text-containing image that includes an image of the 22^{nd} symbol in the example symbol set shown in FIG. 6. FIG. 8B includes a rectangular symbol image 804 extracted from the text-containing image corresponding to the 48^{th} symbol in the example symbol set shown in FIG. 6. In printing and writing of the hypothetical language corresponding to the example symbol set, the symbols are centered within rectangular symbol areas. When this is not the case, initial processing steps carried out by OCR systems may reorient, rescale, and reposition extracted symbol images with respect to a background area in order to normalize extracted symbol images for subsequent processing steps.

FIG. 8A illustrates three different parameters that may be used by an OCR system to characterize symbols. Note that the area of the symbol image, or symbol window, is characterized by a vertical symbol-window dimension 806, abbreviated “vw”) and a horizontal symbol-window dimension 808, referred to as “hw.” A first parameter is the longest horizontal continuous line segment within the symbol image, referred to as “h” 810. This is the longest sequence of contiguous dark pixels within the generally white-pixel background of the symbol window. A second parameter is the longest vertical continuous line segment 812 within the symbol image. A third parameter is the percentage of pixels in the symbol window corresponding to the symbol image, in the current case, the percentage of black pixels within the generally white symbol window. In all three cases, parameter values can be straightforwardly computed once a bitmap for the symbol window has been generated. FIG. 8B shows two additional parameters. The first parameter is the number of horizontal, internal white-space stripes within the symbol image, with the symbol represented by the symbol image shown in FIG. 8B having a single horizontal internal white-space stripe 816. A second parameter is the number of vertical internal white-space stripes within the symbol image. For the 48^{th} symbol of the symbol set, represented by the image within the symbol window 804 shown in FIG. 8B, there is a single vertical internal white-space stripe 818. The number of horizontal white-space stripes is referred to as “hs” and the number of internal vertical white-space stripes is referred to as “vs.”

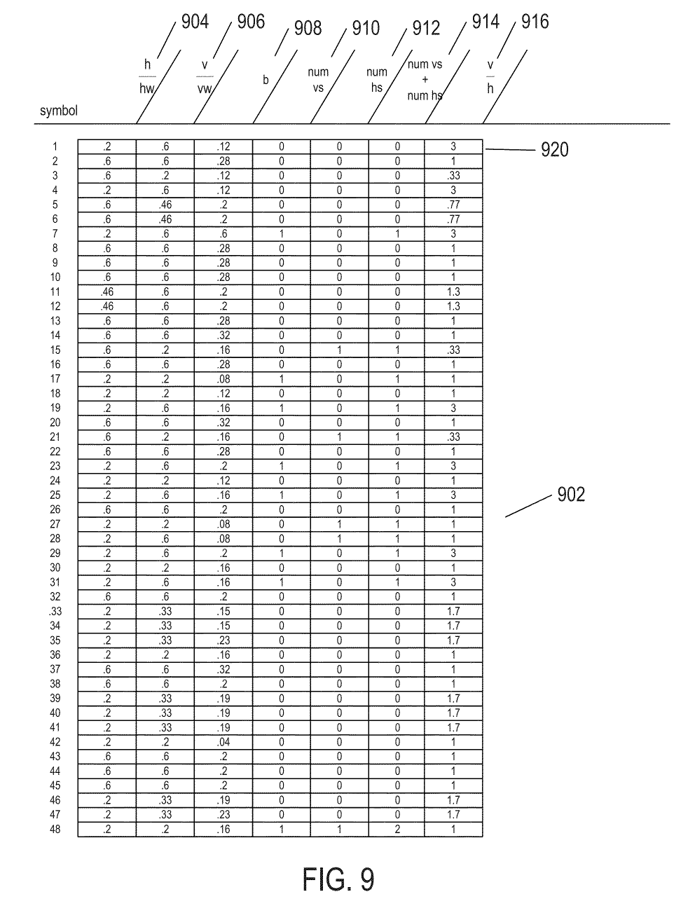

FIG. 9 shows a table of parameter values computed for all of the symbols in the example symbol set shown in FIG. 6. In the table 902 shown in FIG. 9, calculated parameter values for a particular symbol are shown in each row of the table. The parameters include: (1) the longest horizontal continuous line segment relative to the symbol window,

$$\frac{h}{hw} ,$$

904; (2) the longest vertical continuous line segment relative to the vertical symbol-window dimension,

$$\frac{v}{vw} ,$$

906; (3) the percent total area corresponding to the symbol image, or black space, b, 908; (4) the number of internal vertical stripes, vs, 910; (5) the number of horizontal internal stripes, hs, 912; (6) the sum of the number of internal vertical stripes and horizontal stripes, vs+hs, 914; and (7) the ratio of the longest vertical line segment to the longest horizontal line segment,

$$\frac{v}{h} ,$$

916. Thus, considering the first row 920 of table 902 in FIG. 9, the first symbol of the symbol set (606 in FIG. 6) is a vertical bar, and thus, as would be expected, the numeric value of

$$\frac{v}{vw} ,$$

0.6, is significantly greater than the numeric value of

$$\frac{h}{hw} ,$$

0.2. Symbol 606 represents only 12 percent of the entire symbol window 602. There are no internal horizontal or vertical white spaces within symbol 606, and thus vs, hs, and vs+hs are all 0. The ratio

$$\frac{v}{h}$$

is 3. Because the example symbols are all relatively simple and block-like, there are relatively few different values for each of the parameters in table 902.

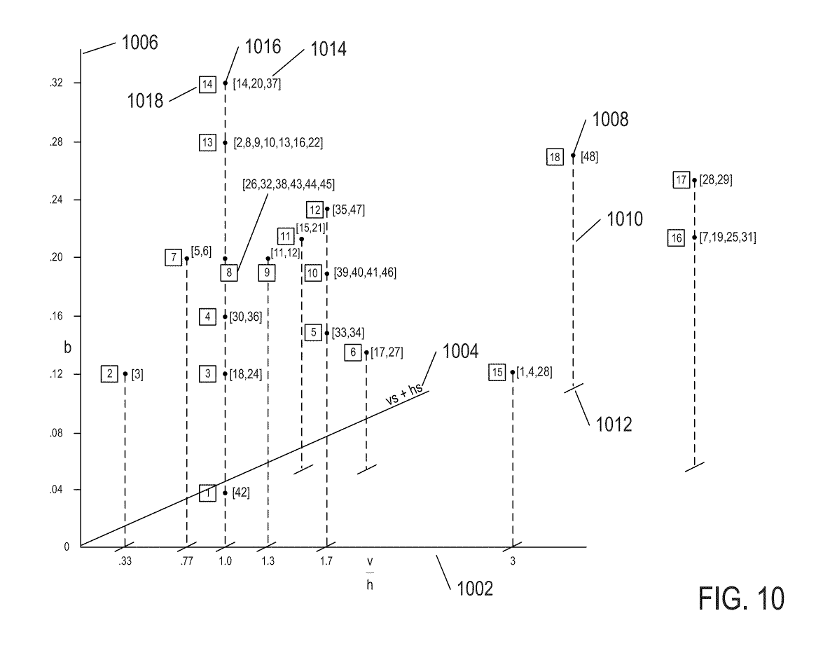

Despite the fact that each of the parameters discussed above with reference to FIG. 9 have only relatively few different parameters values with respect to the 48 example characters, only three of the parameters are sufficient to partition the example characters into 18 partitions, or clusters. FIG. 10 illustrates a three-dimensional plot of the symbols of the example set of symbols shown in FIG. 6 within a three-dimensional space, where the dimensions represent values of each of three different parameters. In FIG. 10, a first horizontal axis 1002 represents the parameter

$$\frac{v}{h}$$

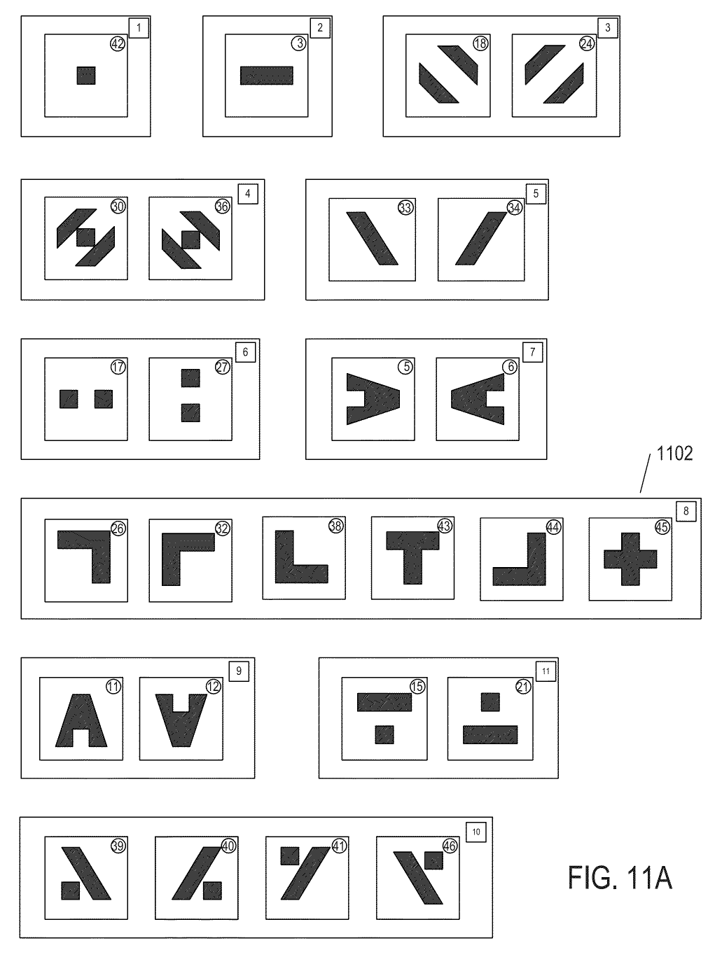

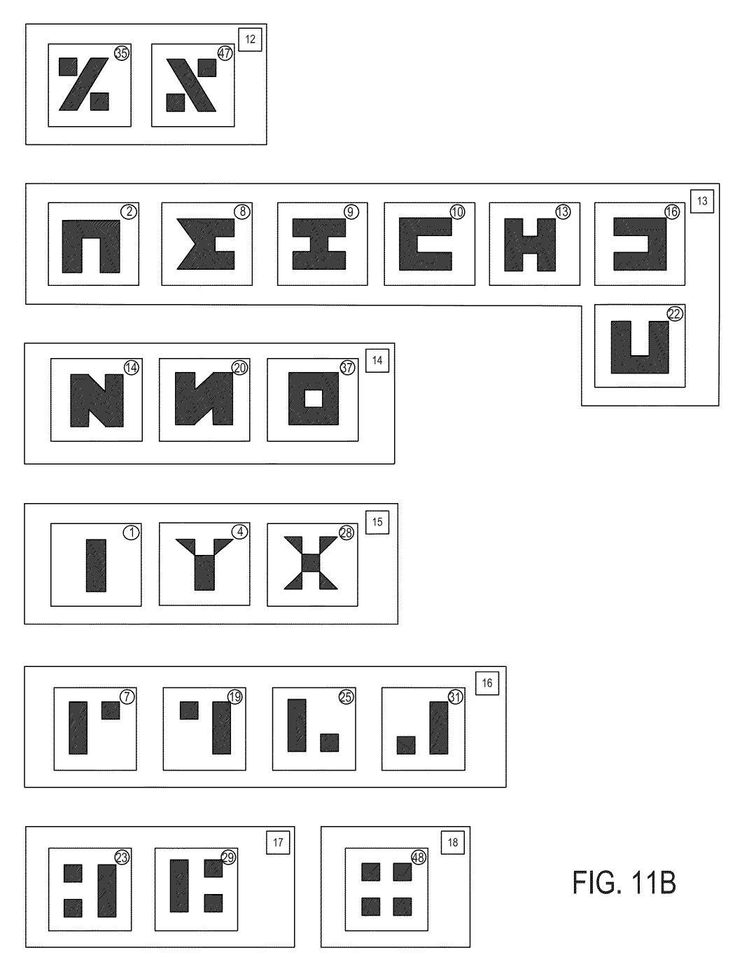

(916 in FIG. 9), a second horizontal axis 1004 represents the parameter vs+hs (914 in FIG. 9), and a third, vertical axis 1006 represents the parameter b (908 in FIG. 9). There are 18 different plotted points, such as plotted point 1008, each shown as a small darkened disk, with the vertical projection of the point down to the horizontal plane that includes axes 1002 and 1004 represented by a vertical dashed line, such as vertical dashed line 1010 connecting point 1008 to its projection on the horizontal plane 1012. The code or sequence number for the symbols that map to a particular point are shown within brackets to the right of the point. For example, symbols 14, 20, and 37 (1014) all map to point 1016 with coordinates (1, 0, 0.32) with respect to axes 1002, 1004, and 1006. Each point is associated with a partition or cluster number in a small rectangle to the left of the point. For example, point 1016 is associated with cluster number “14” 1018. FIGS. 11A-B show the symbols contained in each of the clusters represented by points in the three-dimensional space shown in FIG. 10. As can be readily observed from the symbol contents of these clusters, or partitions, the three parameters employed to distribute the symbols within the three-dimensional space shown in FIG. 10 are actually effective in partitioning the 48 example symbols into related sets of symbols.

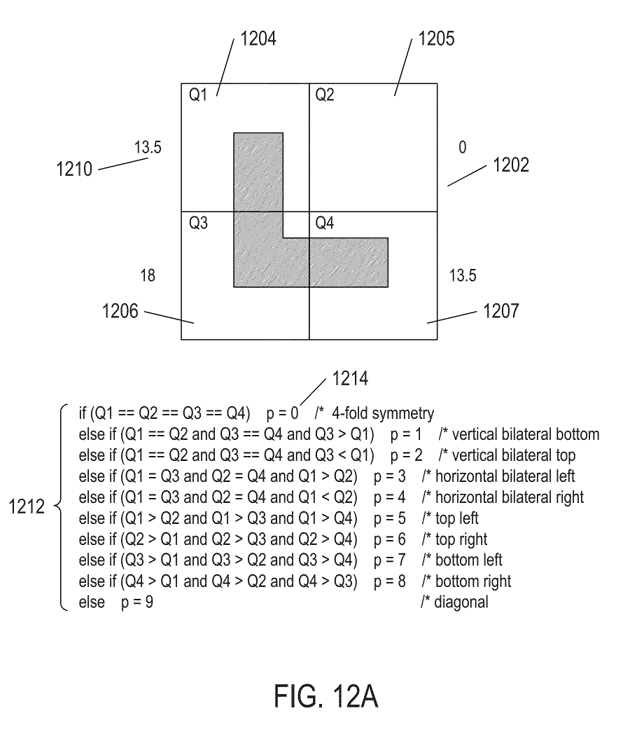

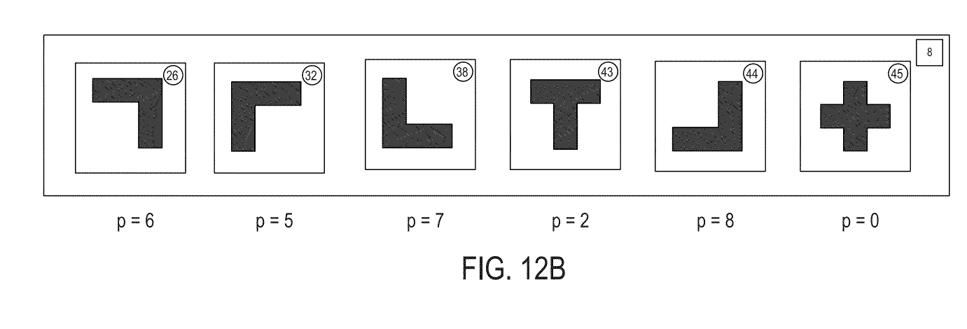

Additional parameters can be used in order to uniquely distinguish each symbol within each cluster or partition. Consider, for example, cluster 8 (1102) shown in FIG. 11A. This cluster of symbols includes four angular, “L”-like symbols with four-fold rotational variations have symbol codes 26, 32, 38, and 44, as well as the “T”-like symbol with symbol code 43 and the cross-sign-like symbol with symbol code 45. FIG. 12A illustrates a different parameter that can be used, in combination with the three parameters corresponding to dimensions in the three-dimensional parameter space shown in FIG. 10, to fully distinguish each of the symbols in cluster 8. As shown in the symbol window 1202 in FIG. 12A, the symbol window is divided into four quadrants Q1 1204, Q2 1205, Q3 1206, and Q4 1207. The number of units of area within the quadrant occupied by the symbol image is then computed and shown adjacent to the quadrant. For example, 13.5 units of area 1210 are occupied by the portion of the symbol image in quadrant Q1 1204. These values for the number of units of area within each quadrant are then assigned to the variables Q1, Q2, Q3, and Q4. Thus, in the example shown in FIG. 12A, the variable Q1 is assigned the value 13.5, the variable Q2 is assigned the value 0, the variable Q3 is assigned the value 18, and the variable Q4 is assigned the value 13.5. Then, the value for the new parameter p is computed according to the small pseudocode snippet 1212 shown in FIG. 12A below the symbol window. For example, when all four variables Q1, Q2, Q3, and Q4 have the same value, then the parameter p is assigned the value 0 (1214), indicating a four-fold symmetry in the symbol window with respect to the number of units of area occupied by the symbol image. FIG. 12B illustrates the value of the additional parameter, discussed with reference to FIG. 12A, for each of the symbols in cluster 8. As can be seen from the parameters values associated with the symbols in FIG. 12B, the new parameter, discussed above with reference to FIG. 12A, has a different value for each of the six symbols in cluster 8. In other words, a combination of the three parameters used to create the three-dimensional plot shown in FIG. 10 and the additional parameter discussed above with reference to FIG. 12A can be used together to uniquely identify all of the symbols in cluster 8.

The above-described methods for symbol recognition fall into a general class of methods referred to as “feature-based” or “parameter-based” symbol recognition methods. There are additional classes of symbol recognition methods, many of which can be used together with, or as alternatives to, feature-based symbol-recognition methods. The additional classes of symbol-recognition methods include: (1) pattern-matching methods, in which symbol images are compared, using scaling and rotation, to a set of canonical patterns to find best matching canonical patterns; (2) feature-bases and/or pattern-matching-based methods applied to outer contours of symbol images; (3) feature-bases and/or pattern-matching-based methods applied to structures determined for symbol images, the structures representing the result of a type of continuous center-of-mass-like computation that produces stick-figure-like representations of symbol images; and (4) additional methods. The above-described feature-based or parameter-based symbol recognition methods represent only a subset of the many types of symbol-recognition methods that can be used for processing document images by the currently disclosed optical-symbol-recognition systems.

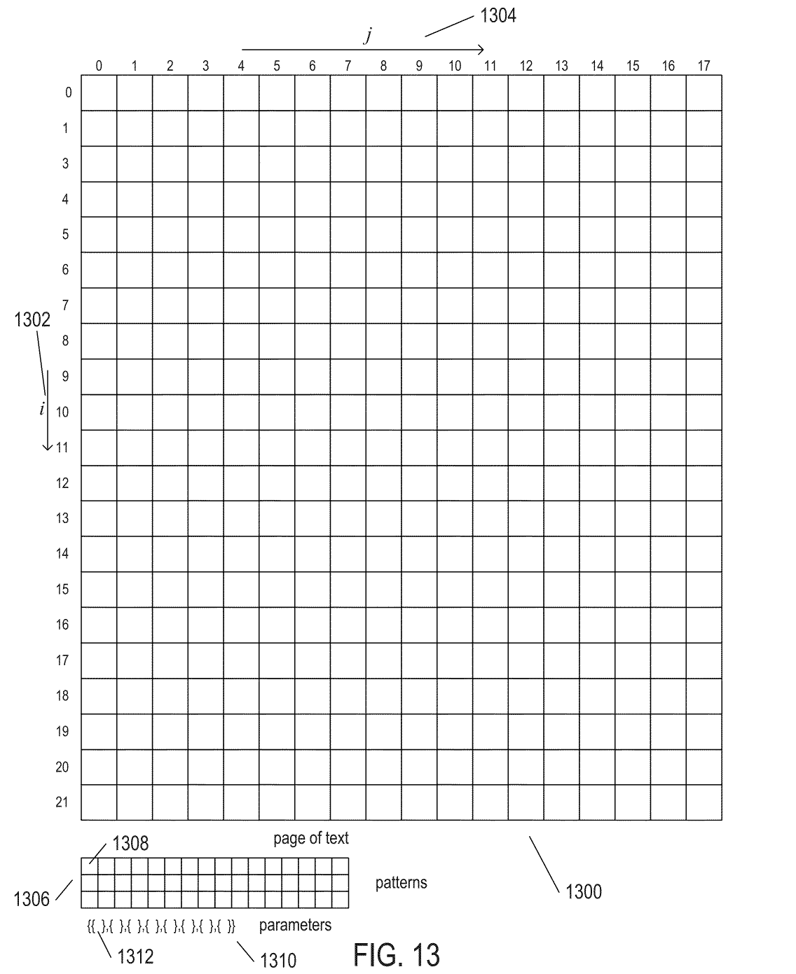

FIG. 13 illustrates a small text-containing image that has been initially processed, by an OCR system, to produce a grid of symbol windows 1300, each containing a symbol image. Only the grid of symbol windows 1300 is shown in FIG. 13, without the symbol images contained within them, for clarity of illustration. The symbol windows are indexed by a vertical index i 1302 and a horizontal index j 1304. In this example, discussed below, for the sake of simplicity, symbols and symbol images are discussed, rather than graphemes. In the example, it is assumed that there is a one-to-one correspondence between symbols, graphemes, and patterns used to identify symbol images in symbol windows. In addition to the grid of symbol windows 1300, FIG. 13 also shows an array or matrix 1306 of patterns, each cell of which, such as cell 1308, including a pattern. Patterns are represented a sets of parameter/parameter-value pairs, with parameters chosen to uniquely distinguish symbol images, as discussed above with reference to FIGS. 8A-12B. FIG. 13 also shows an array of parameters 1310, illustrated as a set containing pairs of braces, such as the pair of braces 1312. Each pair of braces represents the functionality that computes a parameter value for a parameter with respect to a symbol image.

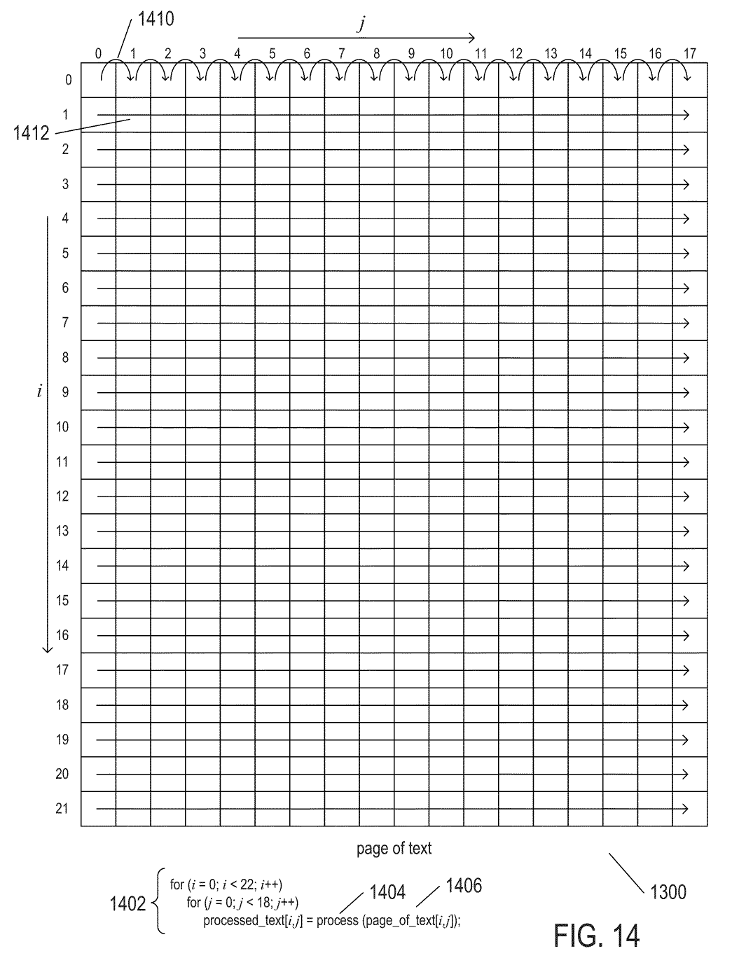

FIG. 14 illustrates a general approach to processing of the grid of symbol windows, shown in FIG. 13. At the highest level, processing can be considered to be a nested for-loop 1402 in which a routine “process” 1404 is called to analyze each symbol window 1406 in order to produce a corresponding symbol code 1408. In other words, the grid of symbol windows is represented, in the pseudocode example, as the two-dimensional array “page_of_text,” and OCR processing generates a two-dimensional array of symbol codes “processed text” from the two-dimensional array of symbol windows “page_of_text.” In FIG. 14, curved arrows, such as curved arrow 1410, are used to show the traversal of the first row of the two-dimensional array, or grid, of symbol windows 1300 and horizontal arrows, such as arrow 1412, illustrate processing of the subsequent rows by for-loop 1402. In other words, the grid of symbol windows 1300 is traversed according to a traversal path and each symbol window in the grid is separately processed to produce a corresponding symbol code.

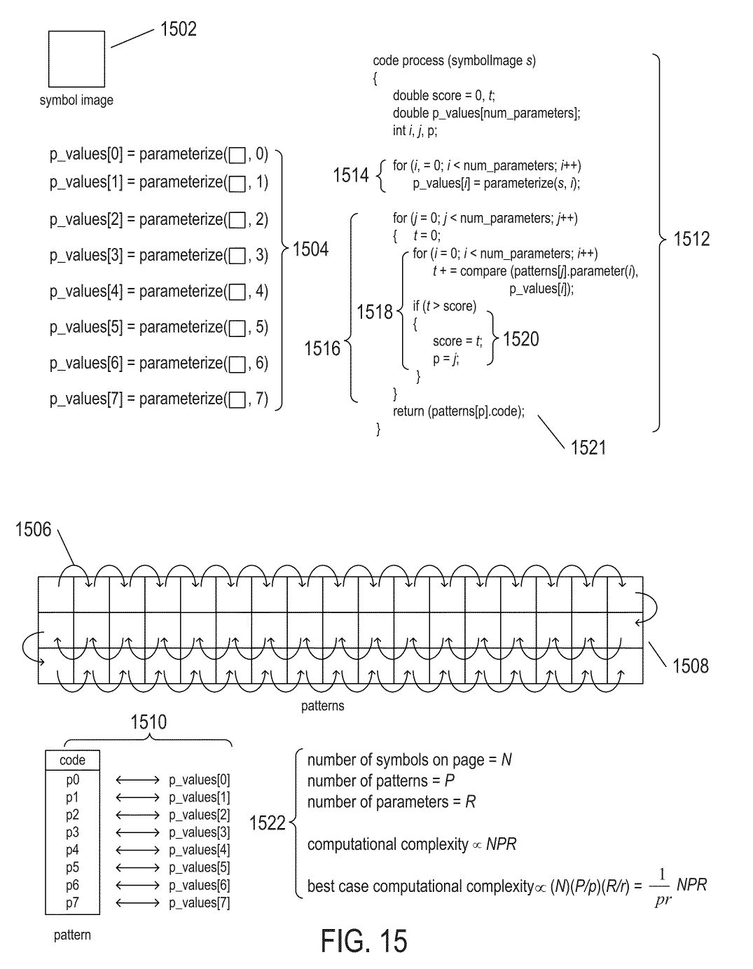

FIG. 15 illustrates a first approach to implementing the routine “process” (1404 in FIG. 14). A symbol image within a symbol window 1502 is input to the routine “process.” The routine “process” computes parameter values p1-p8 for eight different parameters used in the example to characterize symbol images by calling a routine “parameterize,” as shown by the eight calls to this routine 1504 in FIG. 15. The routine “parameterize” receives, as arguments, the symbol image and an integer indicating for which parameter to compute a parameter value and returns the computed parameter value. The parameter values are stored in an array of parameter values “p_values.” Then, as shown by curved arrows, such as curved arrow 1506, the routine “process” traverses all of the patterns 1508 corresponding to symbols of the language, comparing the computed parameter values for the symbol image stored in the array “p_values” to precomputed parameter values for each pattern, as shown in the illustration of the comparison operation 1510 in FIG. 15. The pattern that best matches the computed parameters for the symbol image is chosen as the matching pattern, and the symbol code corresponding to that pattern is returned as the return value of the routine “process.” Pseudocode for this first implementation of the routine “process” is also shown in FIG. 15 as pseudocode example 1512. In a first for-loop 1514, the values for the parameters with respect to the input symbol s are computed. Then, in the outer for-loop 1516 of a set of nested for-loops, each pattern in an array or vector of patterns 1508 is considered, the traversal of the array indicated by curved arrows, such as curved arrow 1506. In an inner for-loop 1518, a routine “compare” is called to compare each computed parameter value for the symbol image to a corresponding precomputed parameter value for the pattern, with the sum of the results of the comparisons accumulated in a local variable t. The highest accumulated comparison value is stored in a local variable score and the index of the pattern that most closely matches the symbol image within the input symbol window is stored in a variable p 1520. The symbol code associated with the pattern p is returned as the result of the routine “process” 1520.

Finally, in FIG. 15, a rough characterization of the computational complexity for the first implementation of the routine “process” 1522 is shown. The number of symbol windows in the text-containing image is N=i×j. In the current example, N=357. Of course, the number of symbol images to be processed depends on the type of document and number of document images as well as on the language and other parameters. However, in general, N varies from tens to hundreds of symbol images per document image. The number of patterns against which symbol images are matched is represented by P. For many alphabetic languages, including most European languages, the number of patterns may be relatively small, generally some relatively small multiple of the number of characters in the alphabet. However, for languages such as Chinese, Japanese, and Korean, the number of patterns may vary from tens of thousands to hundreds of thousands. Thus, for processing such languages, P is much larger than N. The number of parameters used to characterize each symbol image and pattern is represented as R. The overall computational complexity is therefore estimated as NPR. The factor N comes from the outer nested for-loops shown in FIG. 14. The factors PR come from the nested for-loops 1516 and 1518 in the implementation of the routine “process” 1512 shown in FIG. 15. In other words, the routine “process” is called once for each of N symbol images, and each invocation or call to the routine “process” involves R comparisons for each of P patterns. The initial parameter-value computation is considered a constant overhead, in this analysis. There are many possible ways for improving the implementation illustrated in FIG. 15. As one example, the comparison operation may consider only a subset of parameters of the total number of parameters needed to uniquely characterize a symbol image with respect to a particular pattern. Thus, an average number of parameter comparisons

$$\frac{R}{r}$$

may be needed, rather than R comparisons. Additionally, rather than comparing each symbol image with each pattern, the symbol images may be traversed until a pattern that produces a comparison score above some relatively high threshold is found. In this case, the number of patterns that are compared in each symbol image may be

$$\frac{P}{p}$$

rather than P. But, using these improvements, the computational complexity is nonetheless proportional to some generally large fraction of NPR.

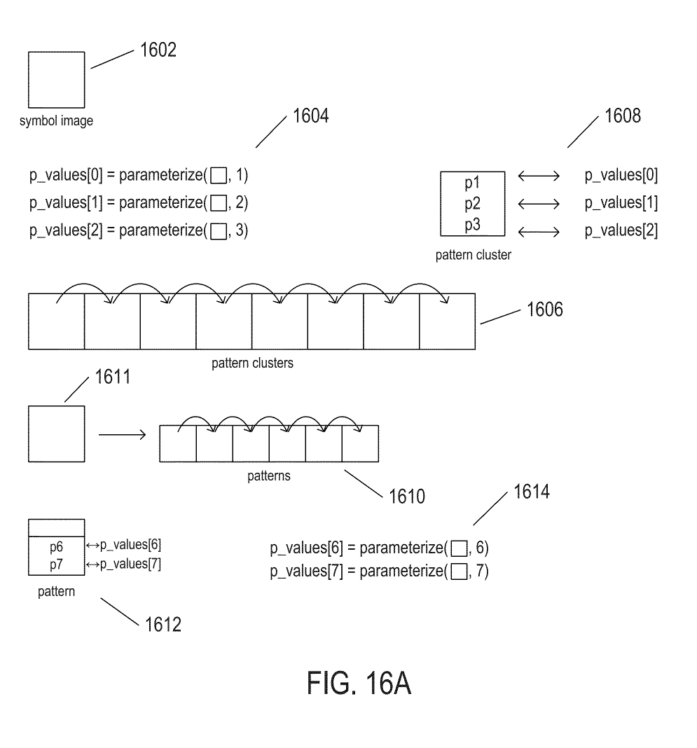

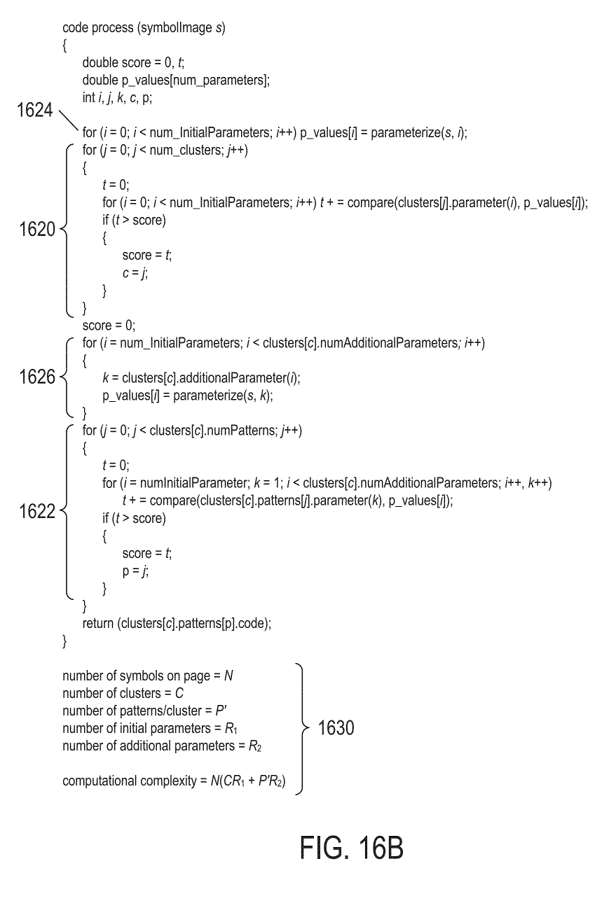

FIGS. 16A-B illustrate a second implementation of the routine “process” (1404 in FIG. 14). In the second implementation, the routine “process” also receives a symbol image 1602 as input. However, in this implementation, the patterns are grouped together into clusters, such as the clusters discussed above with reference to FIGS. 11A-B. The routine “process” computes a sufficient number of parameter values 1604 in order to traverse the clusters of patterns 1606 to identify the most likely matching cluster. Thus, a relatively modest comparison operation 1608 is initially used to select the best pattern cluster. Then, the patterns 1610 within the selected pattern cluster 1611 are traversed using a second, modest comparison operation 1612 that involves some additional number of parameter values 1614 needed to distinguish the best pattern from the relatively small number of patterns 1610 contained in the pattern cluster. Pseudocode for the second implementation of the routine “process” is provided in FIG. 16B. In a first nested for-loop 1620, the most likely or best pattern cluster is selected from among the pattern clusters and in a second nested for-loop 1622, the best pattern from among the patterns within the selected cluster is identified. The initial set of parameters used for determining the best cluster is computed in for-loop 1624 and the additional parameters needed to select a pattern from among the patterns of the selected cluster are computed in the for-loop 1626. FIG. 16B also indicates a rough estimate of the computational complexity for the second implementation of the routine “process” 1630. As indicated, the estimate for the computational complexity for this second implementation of the routine “process” is:

N(CR₁+P′R₂),

where the number of symbols on page=N;
number of clusters=C;
number of patterns/cluster=P;
number of initial parameters=R;
number of additional parameters=R₂.
   Because P′ is generally far smaller than P, and because C is even smaller still, the computational complexity for the second implementation of the routine “process” is quite favorable compared to the computational complexity for the first implementation of the routine “process.”

Another approach to speeding up the first implementation of the routine “process,” discussed above with reference to FIG. 15, is to sort the patterns in the vector or array of patterns so that the most likely patterns corresponding to the most frequently occurring symbols will be first encountered while traversing the vector or array of patterns. When the search for a matching pattern is truncated by finding a pattern with a comparison score greater than some threshold value, and when the patterns are sorted by a frequency of occurrence reflective of the frequency of occurrence of symbols in the text-containing image that is being processed, a significant decrease in computational complexity is obtained. However, the frequency of occurrence of symbols in particular text-containing images may vary enormously depending on the type of document or page that was scanned to produce the image, and is unknown prior to OCR processing. A sorting of the patterns that produces a significant decrease in computational complexity for one type of document may, for another type of document, significantly increase the computational complexity. For example, an overall statistical analysis of all different types of text documents in a particular language, including novels, advertisements, textbooks, and other such documents, may produce a general frequency-of-occurrence-of-symbols sorting of patterns. However, certain documents and specialized fields may have an entirely different set of frequencies of occurrence of symbols. In this case, for the documents of the particular field, the most frequently occurring characters may end up towards the end of the traversal path through the vector or matrix of patterns sorted according to the general frequency-of-occurrence-of-symbols sorting of patterns. The second implementation of the routine “process,” discussed above with reference to FIGS. 16A-B, generally produces a significant decrease in computational complexity and corresponding increase in processing speeds. In general, a much smaller number of comparisons are needed in order to find a matching pattern for each symbol image. However, the second implementation is associated with a potentially serious problem in that, should the first nested for-loop that selects the cluster fail, then the routine “process” cannot possibly find the correct matching symbol. The correct matching symbol, in that case, is in a different cluster that is never analyzed in the second nested for-loop. While the examples of symbol sets and clusters provided above are relatively simple, as are the parameters used to characterize them, for the languages such as Chinese and Japanese, the task is far more complex and far more prone to error due to printing imperfections, document damage, and various types of errors that arise in scanning and initial OCR processing steps. Therefore, the chance of improperly choosing a cluster in such real-world problem domains is significant.

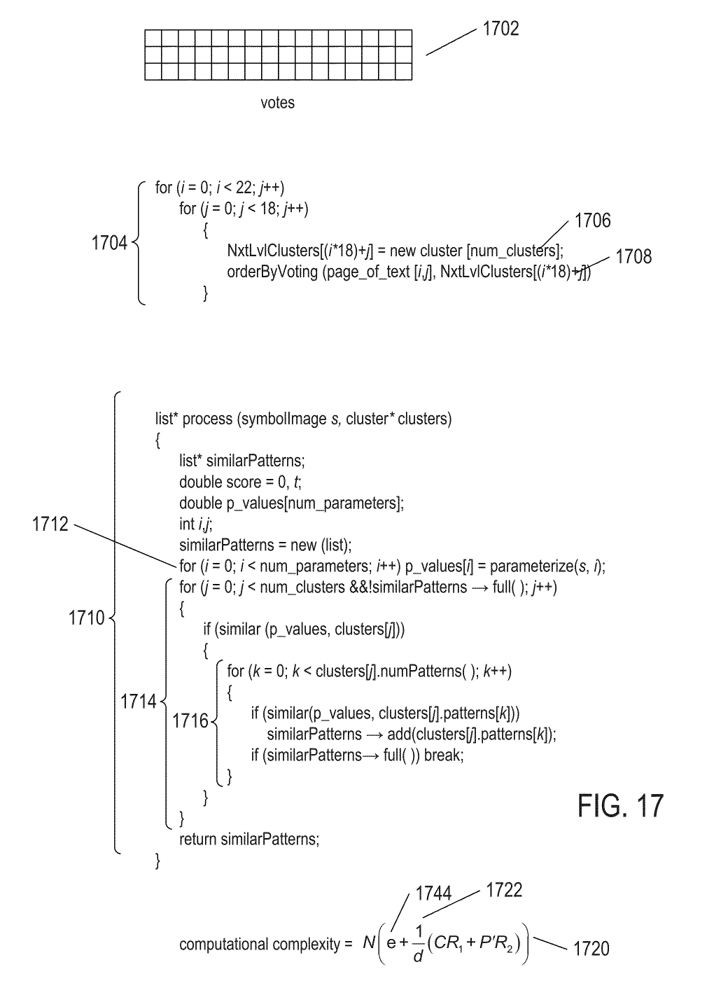

FIG. 17 illustrates a third implementation of the routine “process,” discussed in the previous subsection, using the same illustration and pseudocode conventions used in the previous subsection. As shown in FIG. 17, the third implementation of the routine “process” uses an additional data structure 1702 referred to as “votes.” The votes data structure includes an integer value for each pattern. This data structure is initialized to contain all zero values for all patterns. Then, in a first preprocessing step represented by the doubly nested for-loop 1704 in FIG. 17, a new set of clusters is allocated for each symbol image in the text-containing document 1300 and the patterns within the clusters are ordered based on votes collected within the votes data structure. In other words, the patterns are ordered within the newly allocated set or list of clusters so that those patterns most likely to match the currently considered symbol image are first encountered in a traversal of the patterns. The parameter values for a set of comparison parameters computed for the currently considered symbol image are compared to the parameter values for each pattern, and votes are cast for those patterns that, based on the comparison, have a similarity to the symbol image above a threshold similarity. In certain implementations, the clusters within the set of clusters may also be sorted by cumulative similarity of the patterns within them to the symbol image.

After the preprocessing step carried out in the nested for-loops 1704, each symbol image is processed by a third implementation of the routine “process.” Pseudocode for the third implementation of the routine “process” 1710 is provided in FIG. 17. In this implementation, the routine “process” receives a symbol image and the set of clusters prepared for the symbol image in the preprocessing step and stored in the array NxtLvlClusters and returns a pointer to a list of potentially matching patterns. In a first for-loop 1712, parameter values for parameters used to identify patterns matching the received symbol image are computed. In a second outer for-loop 1714, each cluster is considered until the list of potentially matching patterns is full. In other words, when a maximum number of potentially matching patterns has been found, this outer for-loop is short-circuited. In an inner for-loop 1716, a function “similar” is called for each pattern in a cluster to determine whether the pattern is sufficiently similar to the symbol image to add the pattern to the list of potentially matching patterns. Again, when the list of potentially matching patterns is filled, this inner for-loop is also short-circuited. FIG. 17 provides an estimate for the computational complexity of this third implementation of the routine “process” 1720. Because both the outer and inner for-loops 1714 and 1716 are short-circuited when a sufficient number of potentially matching patterns is found, and because the vectors or lists of patterns within each cluster are sorted by frequency of occurrence in the actual document being processed, only a relatively small fraction of the comparisons needed in the second implementation of the routine “process” are needed by the third implementation, as represented by the fraction

$$\frac{1}{d} 1722.$$

There is, of course, an initial preprocessing penalty represented by the term “e” 1744. However, as discussed above, the number of symbol images that are processed, N, is generally quite small in comparison to P or P′, for languages such as Chinese, Japanese, and Korean, and therefore the third implementation of the routine “process” provides significantly decreased computational complexity in comparison to either the first or second implementations of the routine “process,” discussed above. More importantly, the third implementation of the routine “process” is guaranteed to look through all of the clusters until some maximum number of potentially matching symbols is found. When the threshold for similarity for clusters is set to a relatively low value and the threshold for similarity for patterns is set relatively high, there is a very high probability that the list of potentially matching symbols returned by the routine “process” will include the actual symbol that best matches the input symbol image.

The above discussion, including the third implementation outlined in FIG. 17, provides a context for describing a particular aspect of this generalized third implementation to which the current document is directed. It should be clearly understood that the above-described implementations are generalized implementations and that any particular implementation of an OCR system may use any of a large number of different possible alternative implementations.

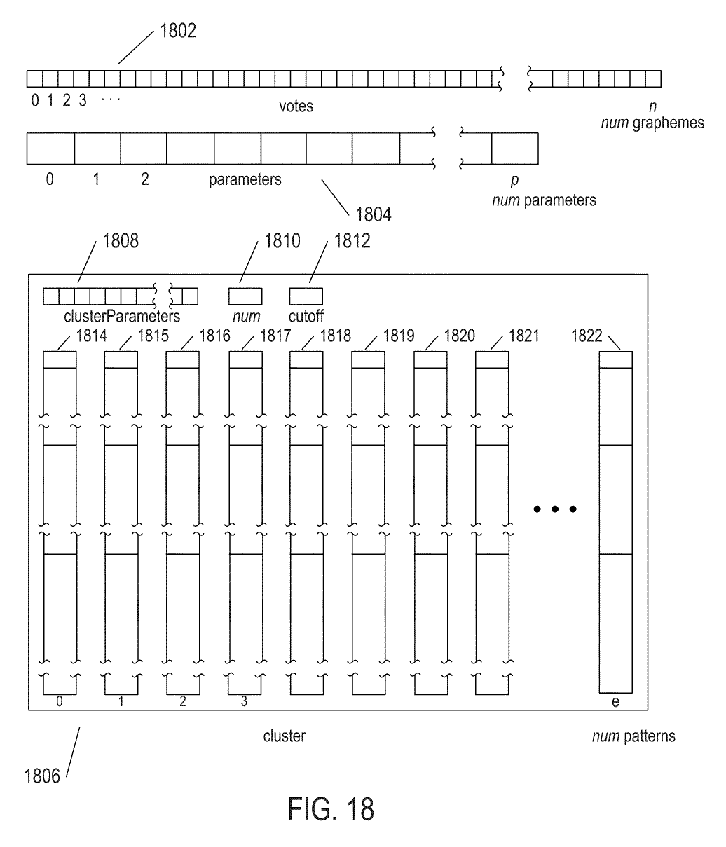

Control logic and data structures within an OCR system allow for both clustering of patterns as well as for the above-described preprocessing step in which graphemes within patterns can be sorted by the frequency of occurrence of the graphemes within a text-containing scanned image or set of scanned images. These control logic and data structures are used in a preprocessing/clustering OCR implementation in which a fixed set of parameters is associated with each cluster and used in symbol-image/pattern comparisons with respect to patterns contained in the cluster. The clusters may be used in different local operations or phases of a complex OCR processing task, and the particular parameters used, and the number of parameters used, for symbol-image/pattern comparisons with respect to patterns contained in the cluster may differ in different local operations and phases, and may often differ among different clusters. FIG. 18 illustrates data structures that provide for clustering and preprocessing in one implementation of an OCR system that incorporates the general third implementation of the routine “process,” described above. A first data structure is an array or vector 1802 referred to as “votes.” In a described implementation, the array “votes” includes one element for each of the graphemes for a language. The array “votes” is indexed by integer grapheme codes. In other words, each grapheme is assigned a unique integer identifier, and that unique identifier, or code, for a grapheme serves as an index into the array “votes.” As shown in FIG. 18, the array “votes” may be implemented with n entries, where n is the number of graphemes in the language and the grapheme codes monotonically increase from 0 to n. Of course, the data structure “votes” may be alternatively implemented as a sparse array, when grapheme codes are not monotonically increasing, as a list, or using other types of data structures.

FIG. 18 shows a second data structure 1804 which is an array of instances of the class “parameter.” As with the data structure “votes,” the array “parameters” may be alternatively implemented by various alternative data structures, including lists, sparse arrays, and other data structures. In the currently described implementation, the array “parameters” includes p entries or elements that are indexed by monotonically increasing parameter numbers 0, 1, 2, . . . , p. Each instance of the class “parameter” represents one of the various parameters used to characterize symbol images and patterns, as discussed above.

FIG. 18 additionally shows a cluster data structure 1806 that represents a cluster or set of patterns. The cluster data structure includes an array “clusterParameters” 1808 that represents the parameters used to characterize the patterns within the cluster at a particular point in time as well as to characterize symbol images for comparison with the patterns contained in the cluster. Each element in the array “clusterParameters” contains an index into the array “parameters” 1804. By using indices into the array “parameters” 1804, the particular parameters and the number of parameters used for comparisons can be easily changed or reconfigured, so that the cluster can be efficiently reconfigured for different local operations or phases. The cluster data structure also includes an integer num 1810 that indicates the number of parameter indices contained in the array “clusterParameters.” The cluster data structure additionally contains a double, or floating-point, value, referred to as “cutoff” 1812 that contains a threshold weight for evaluation of patterns, contained in the cluster, with respect to a symbol image. Finally, the cluster data structure 1806 includes a number of pattern data structures 1814-1822. The pattern data structures are discussed below.

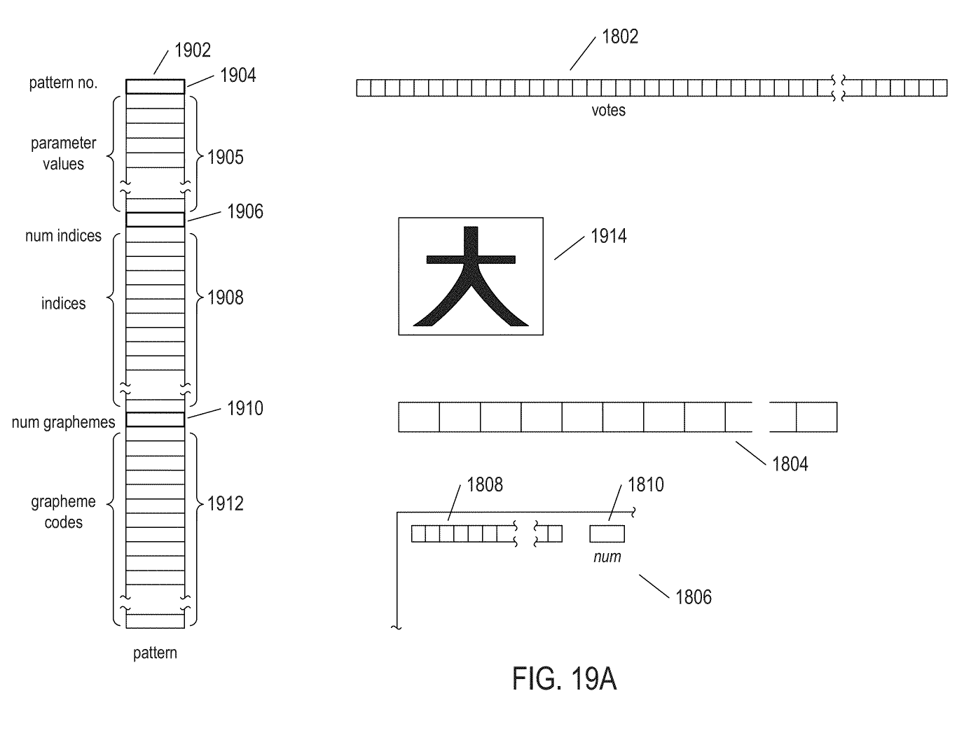

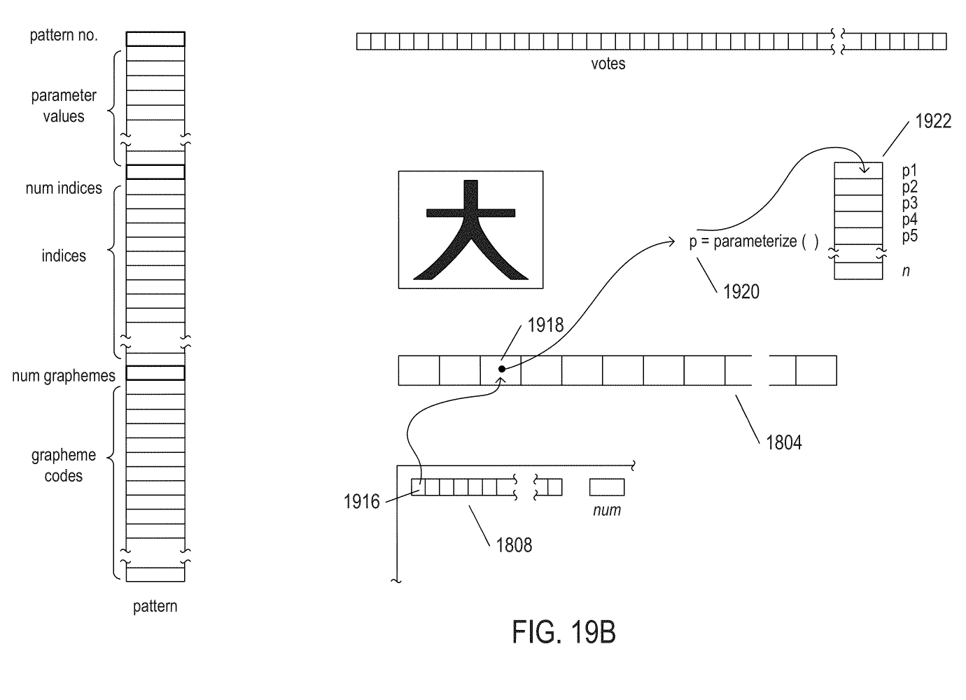

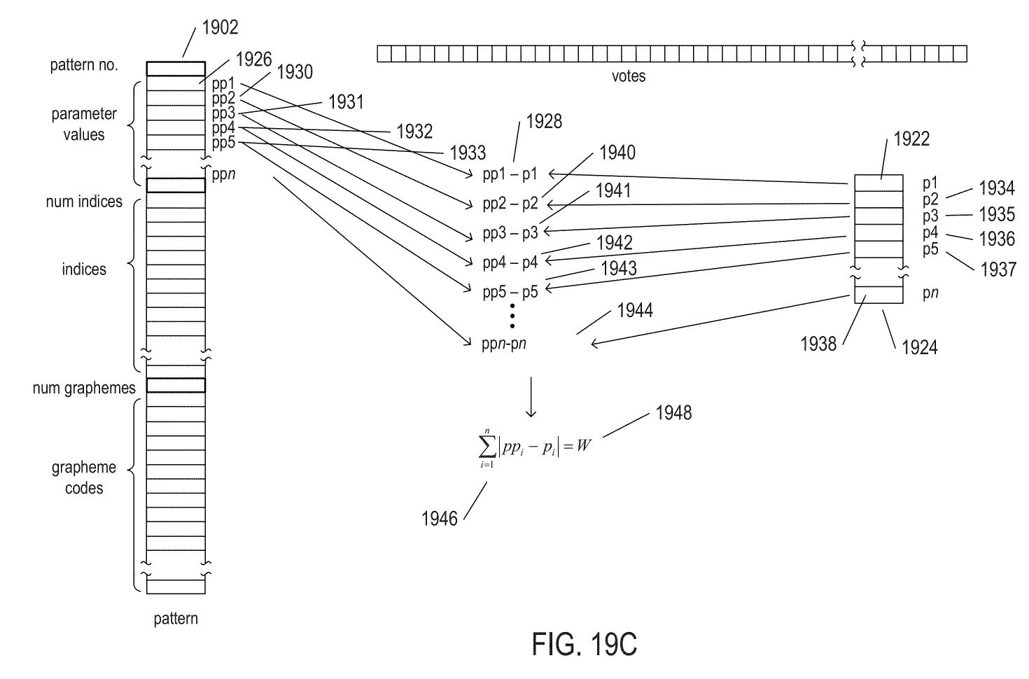

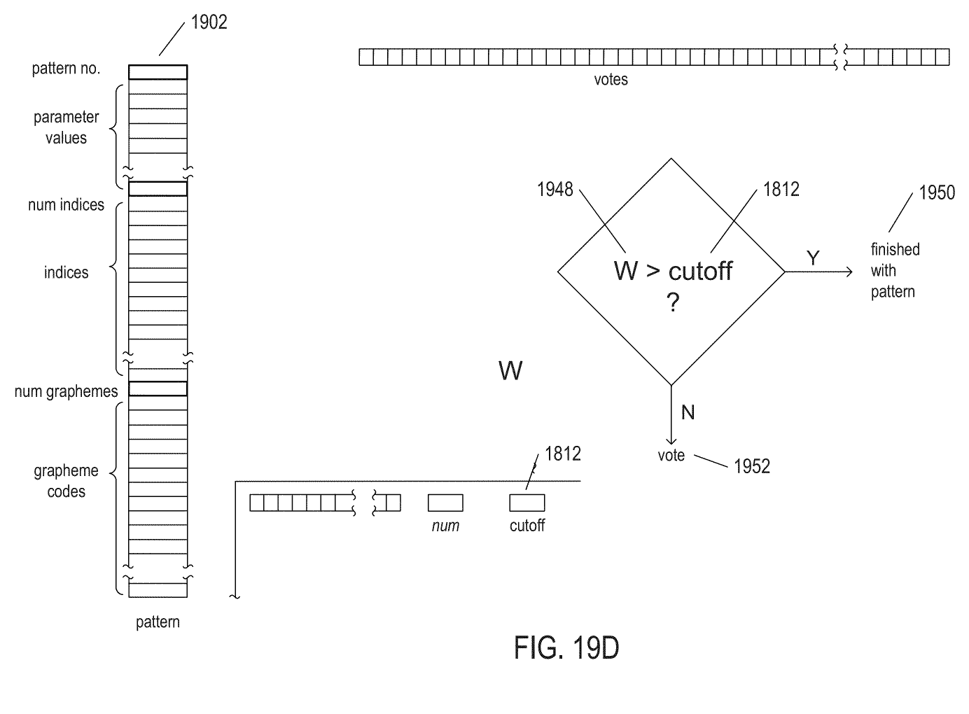

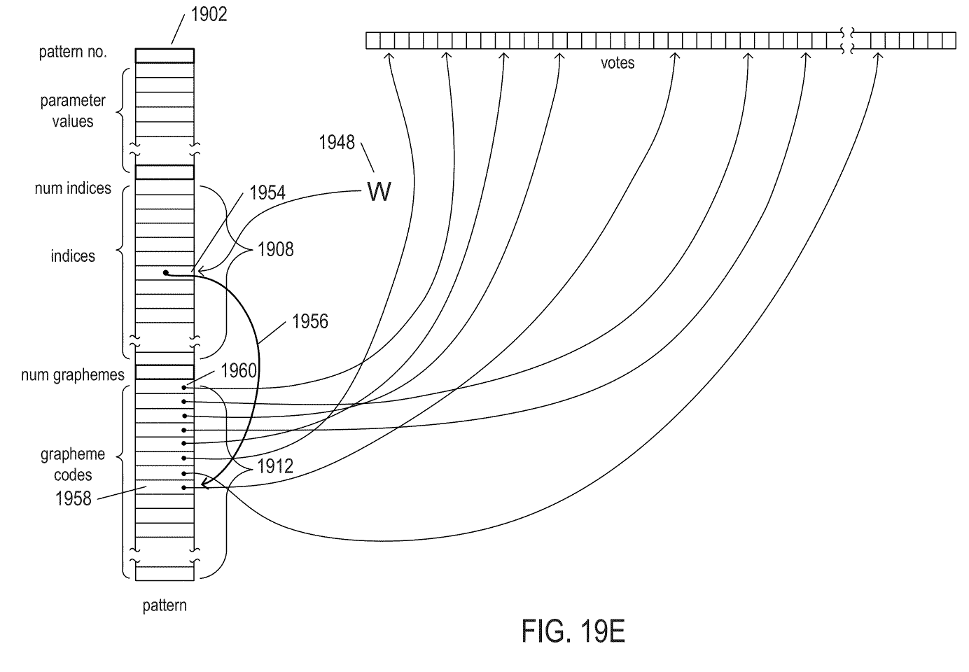

FIGS. 19A-E illustrate preprocessing of a symbol image using the data structures discussed above with reference to FIG. 18. FIG. 19A shows the data structure “votes” 1802, discussed above with reference to FIG. 18, and a single pattern data structure 1902 selected from the patterns contained in the cluster data structure 1806, also discussed above with reference to FIG. 18. Each pattern data structure includes a pattern number 1904 and a set of parameter values 1905 computed for the pattern using the parameters referenced by indexes contained in the “clusterParameters” array 1808 within the cluster data structure 1806. As noted above, it is important to remember that symbol images are scaled, rotated, and translated to create normalized symbol images to facilitate parameter-based comparisons between symbol images and patterns. The pattern data structure additionally includes an integer 1906 that indicates the number of indices within the pattern data structure, and then the indicated number of indices 1908. These indices are associated with the different possible weights that can be computed during comparison of a symbol image with a pattern. In one implementation, there may be as many indices within the pattern data structure as there are possible computed weights, with each index comprising an integer index as well as the computed weight associated with the index. Other implementations are possible. When a symbol image is parameterized, and the parameter values for the symbol image compared to the pattern represented by the pattern data structure, a weight is produced. The greater the weight value, the less well the symbol image matches the pattern. This weight is used to select a corresponding index, from the indices, that is used to select a number of graphemes corresponding to the pattern for which to vote, during the preprocessing step. Each pattern data structure includes an integer indicating the number of graphemes corresponding to the pattern 1910 and then one code for each grapheme of the set of graphemes corresponding to the pattern 1912. In many implementations, these grapheme codes are sorted with respect to similarity or closeness to the encompassing pattern, in decreasing similarity order.

FIGS. 19A-E illustrate preprocessing of a single symbol image selected from a text-containing scanned image. In the example of FIGS. 19A-E, the symbol image 1914 represents a character from an Asian language. FIG. 19A also shows the array “parameters” 1804, discussed above with reference to FIG. 18, and a small portion of the clusters data structure 1806 that includes the array “clusterParameters” 1808 and the integer num 1810.

As shown in FIG. 19B, for each of the num parameters, indexes for which are included in the array “clusterParameters” 1808, the index for a parameter 1916 is extracted from the array “clusterParameters” 1808 and used to access an instance of the class “parameter” 1918 within the array “parameters” 1804. A member function “parameterize” of the instance of the class “parameter” 1918 is called to generate a parameter value 1920 that is then stored in a local variable 1922. FIG. 19B illustrates computation of a first parameter value for the symbol image. When all num instances of the class “parameter” have been invoked to generate num parameter values for the symbol image, a list or array of symbol-image parameter values 1924 is obtained, as shown in FIG. 19C.

Next, as also shown in FIG. 19C, the corresponding parameter value precomputed for the pattern represented by the pattern data structure and parameter for the symbol image are subtracted to produce a series of computed values, one for each parameter. For example, as shown in FIG. 19F, the first parameter value 1926 stored in the pattern data structure 1902 and the first parameter value 1922 computed for the symbol image are subtracted to produce an intermediate value 1928. The remaining predetermined parameter values for the pattern 1930-1933 and the remaining parameter values for the symbol image 1934-1938 are similarly subtracted to produce additional intermediate computed values 1940-1944. The absolute values of these intermediate values 1928 and 1940-1944 are summed 1946 to produce the weight 1948 that numerically represents a parameter-based comparison between the symbol image and the pattern represented by the pattern data structure 1902. Again, the greater the value of the computer weight, the less similar the symbol image to the pattern, as the weight is an accumulation of differences between parameter values for the symbol image and pattern.

As shown in FIG. 19D, when the computed weight 1948 is greater than the cutoff value 1812 for the cluster, the preprocessing for the symbol image with respect to the pattern represented by the pattern data structure 1902 is finished 1950. Otherwise, the preprocessing of the symbol image votes for one or more of the graphemes corresponding to the pattern represented by the pattern data structure 1952.

FIG. 19E illustrates the case when the computed weight that represents the comparison of the symbol image with the pattern represented by the pattern data structure is less than or equal to the cutoff value for the cluster. In this case, the computed weight 1948 is used to select an index 1954 from the set of indices 1908. As discussed above, each of the indices 1908 may contain an index and an associated weight, allowing a particular one of the indices 1954 to be selected by the computed weight 1948, from index which an index into the grapheme codes is extracted. This extracted index points 1956 to a particular grapheme code 1958 within the set of grapheme codes 1912 stored within the pattern data structure to represent those graphemes that correspond to the pattern. Then, for all of the grapheme codes beginning with a first grapheme code 1960 and extending to the grapheme code 1958 pointed to by the extracted index 1956, the corresponding element of the data structure “votes” 1802 is incremented, as represented by the arrows emanating from the elements containing grapheme codes between and including elements 1960 and 1958, such as arrow 1962.

Thus, when the computed weight for the comparison of the symbol image to the pattern is less than the cutoff value, then the symbol image is sufficiently similar to the pattern that at least some of the graphemes corresponding to the pattern deserve a vote in the preprocessing step. Those graphemes sufficiently similar to the symbol image are selected based on the computed weight using an index selected from one of the indices 1908 corresponding to the computed weight. Then, elements of the data structure “votes” corresponding to these graphemes are incremented to reflect votes for these graphemes based on preprocessing of the symbol image.

Next, C++-like pseudocode is provided to illustrate the preprocessing of a symbol image with respect to the patterns within a cluster, as illustrated in FIGS. 19A-E. Relatively simple C++-like pseudocode is employed, including fixed-size arrays and simple control structures. Of course, more efficient, but also more complex, implementations may be used in practical OCR systems, including iterators, data structures that implement associative memory, and other such alternative data structures and associated methods.

First, a number of data structures and class declarations are provided:

| | |
|---|---|
| 1 | int votes[NUM_GRAPHEMES]; |
| 2 | class parameter |
| 3 | { |

| | |
|---|---|
| 4 | virtual double parameterize (symbolImage* s); |

| | |
|---|---|
| 5 | }; |
| 6 | parameter Parameters [NUM_PARAMETERS]; |
| 7 | class pattern |
| 8 | { |

| | |
|---|---|
| 9 | private : |

| | |
|---|---|
| 10 | int patternNo; |
| 11 | double parameters[MAX_PARAMETERS]; |
| 12 | int numIndices; |
| 13 | int indices[MAX_INDICES]; |
| 14 | int numGraphemes; |
| 15 | int graphemes[MAX_GRAPHEMES]; |

| | |
|---|---|
| 16 | public : |

| | |
|---|---|
| 17 | double getParameter (int i); |
| 18 | int getIndex (double w); |
| 19 | int getGrapheme (int i); |
| 20 | pattern ( ); |

| | |
|---|---|
| 21 | }; |
| 22 | class cluster |
| 23 | { |

| | |
|---|---|
| 24 | private : |

| | |
|---|---|
| 25 | int num; |
| 26 | int clusterParameters[MAX_CLUSTER_PARAMETERS]; |
| 27 | double cutoff; |
| 28 | int numPatterns; |
| 29 | pattern*patterns; |

| | |
|---|---|
| 30 | public : |

| | |
|---|---|
| 31 | double getCutoff ( ); |
| 32 | int getNum ( ); |
| 33 | int getParameter (i); |
| 34 | pattern* getPattern (i); |
| 35 | int getNumPatterns ( ); |
| 36 | cluster ( ); |

| | |
|---|---|
| 37 | }; |

The data structure “votes” 1802 is declared on line 1, above. A small portion of a declaration for a class “parameter” is provided on lines 2-5. In the current discussion, the only relevant aspect of the parameter class is that the base class includes a virtual function member “parameterize” that takes, as input, a symbol image and that returns, as output, a floating-point parameter value. Of course, in certain cases, a particular parameter may have only integer values, rather than floating-point values. The data structure “parameters” 1804 is declared on line 6. A portion of a class “pattern” is declared on lines 7-21. The class “pattern” includes private data members “patternNo” (1904 in FIG. 19A), declared on line 10, an array of parameter values “parameters” (1906 in FIG. 19A), declared on line 11, a number of indices “numIndices” (1906 in FIG. 19A), declared on line 12, and a set of indices (1908 in FIG. 19A) of cardinality “numIndices,” declared on line 13, an integer value “numGraphemes” (1910 in FIG. 19A), and a set of grapheme codes “graphemes” (1912 in FIG. 19A), of cardinality “numGraphemes.” The class “pattern” includes the function members “getParameter,” declared on line 17, which returns a parameter value from the set of parameter values “parameters,” the function member “getIndex,” declared on line 18, which returns an index corresponding to a computed weight, and a function member “getGrapheme,” declared on line 19, which returns a grapheme code from the set of grapheme codes “graphemes,” declared on line 15. Finally, the class “cluster” is declared on lines 22-37, representing the cluster data structure 1806 in FIG. 18. The class “cluster” includes private data members num (1810 in FIG. 18), declared on line 25, “clusterParameters” (1808 in FIG. 18), declared on line 26, “cutoff” (1812 in FIG. 18), declared on line 27, an integer indicating the number of patterns within the cluster, “numPatterns,” declared on line 28, and a pointer to the patterns contained within the cluster, “patterns,” declared on line 29. The class “cluster” includes function members to get the cutoff value and number of patterns, “getCutoff” and “getNum,” declared on lines 31 and 32, the function member “getParameter” that retrieves parameter indices from the array “clusterParameters,” declared on line 32, the function member “getPattern” that returns a particular pattern stored within the cluster, declared on line 33, and the function member “getNumPatterns,” declared on line 34, that returns the number of patterns stored within the cluster data structure.

The following pseudocode routine “vote” illustrates implementation of the preprocessing method with respect to a single symbol image and a single cluster:

| | |
|---|---|
| 36 | void vote (symbolImage* s, cluster* c) |
| 37 | { |

| 38 | double params[MAX_PARAMETERS]; |
|---|---|
| 39 | int i, j, k, l; |
| 40 | double weight, t; |
| 41 | pattern* p; |
| 42 | |
| 43 | for (i = 0; i < c → getNum( ); i++) |

| | |
|---|---|
| 44 | params[i] = Parameters[c → getParameter |

(i)].parameterize(s);

| | |
|---|---|
| 45 | for (j = 0; j < c → getNumPattern( ); j++) |
| 46 | { |

| | |
|---|---|
| 47 | p = c → getPattern(i); |
| 48 | weight = 0; |
| 49 | for (i = 0; i < c → getNum( ); c++) |
| 50 | { |

| | |
|---|---|
| 51 | t = p → getParameter (i) − params [i]; |
| 52 | weight + = (t < 0) ? − t : t; |

| | |
|---|---|
| 53 | } |
| 54 | if (weight > c → getCutoff( )) continue; |
| 55 | k = p → getIndex(weight); |
| 56 | for (l = 0; l < k; l++) |

| | |
|---|---|
| 57 | votes[p → getGrapheme(l)]++; |

| | |
|---|---|
| 58 | } |

| | |
|---|---|
| 59 | } |

The routine “vote” receives, as arguments, a pointer to a symbol image and a pointer to a cluster. Local variables include the array “params” declared on line 38, that stores computed parameter values for the symbol image, iteration integers i, j, k, and l, declared on line 39, floating-point variables “weight” and “t,” used to store a computed weight resulting from a comparison between the input symbol image and a pattern within the cluster, and a pointer p, declared on line 41, that points to a pattern within the input cluster. In the for-loop of lines 43-44, parameter values for all the parameters used by the cluster are computed for the input symbol image and stored in the array “params” (1924 in FIG. 19C). Next, in the outer for-loop of the nested for-loops of lines 45-58, each parameter within the input cluster is considered. On line 46, a pointer to the currently considered pattern is obtained by calling the cluster function member “getPattern.” The local variable “weight” is set to 0, on line 48. Then, in the for-loop of lines 49-53, the weight that represents comparison of the input symbol image to the pattern is computed, as discussed above with reference to FIG. 19F. When the weight is greater than the cutoff value for the cluster, as determined on line 54, the current iteration of the outer for-loop of lines 44-58 is short circuited, since the input symbol image is not sufficiently similar to the currently considered pattern for voting. Otherwise, the local variable k is set to the last index of a grapheme code for voting, on line 55. Then, in the for-loop of lines 56-57, all of the graphemes up to the grapheme with code indexed by k are voted for.

There are many different alternative approaches to the preprocessing step and above-described data structures. For example, rather than a cutoff weight for an entire cluster, cutoff weights for particular patterns may be used, with the cutoff weights included in the pattern data structure. As another example, the indices stored within the pattern may be instances of classes that contain lists of grapheme codes, rather than indexes pointed into an ordered list of grapheme codes, as in the currently described implementation. Many other such alternative implementations are possible. For example, the routine “vote” may receive, as a second argument, a pointer to an array “params” and, in the for-loop of lines 43-44, may computer parameter values only when they have not already been computed while processing the symbol image with respect to other clusters. Different types of weight computations and symbol-image-to-pattern comparisons may be used in alternative implementations. In certain cases, larger-valued weights may indicate greater similarity between a symbol image and a pattern, unlike the above-described weights that increase in value as the similarity between a symbol image and a pattern decreases. In certain OCR systems, real coefficients may be associated with graphemes to allow for fractional votes and votes greater than 1. In certain OCR systems, graphemes, patterns, and/or clusters may be sorted, based on votes accumulated during preprocessing, to facilitate efficient subsequent symbol recognition. In certain implementations, a cluster data structure may include only a number of pattern data structures or references to pattern data structures, with the cutoff and patterns associated with the cluster specified in control logic, rather than stored in the cluster data structure.

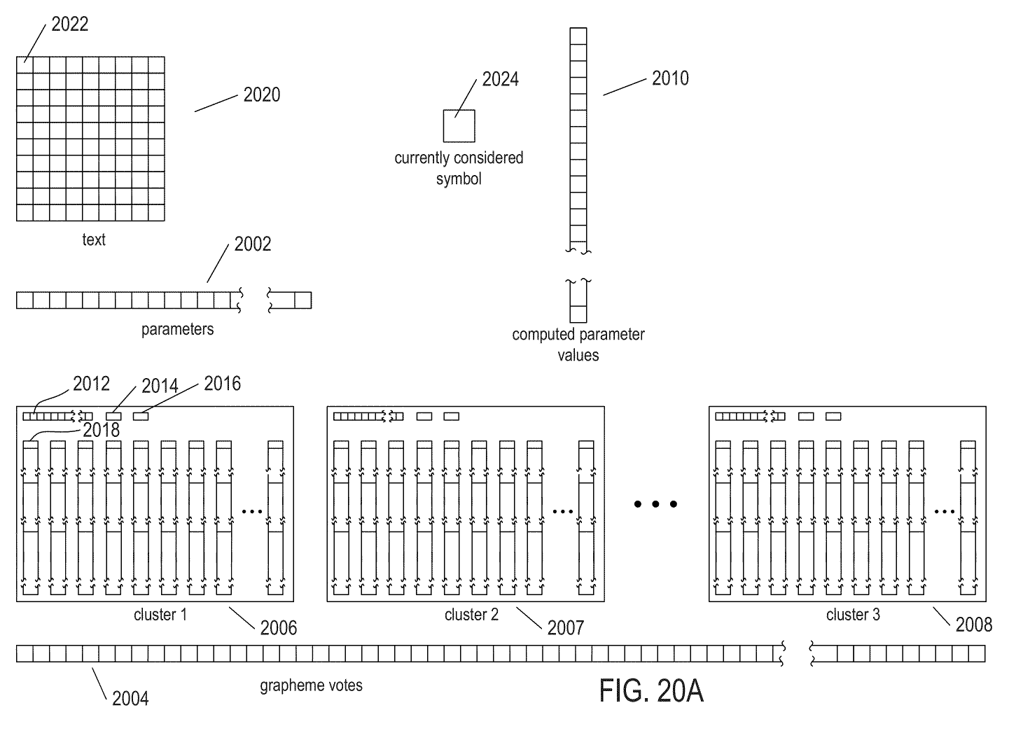

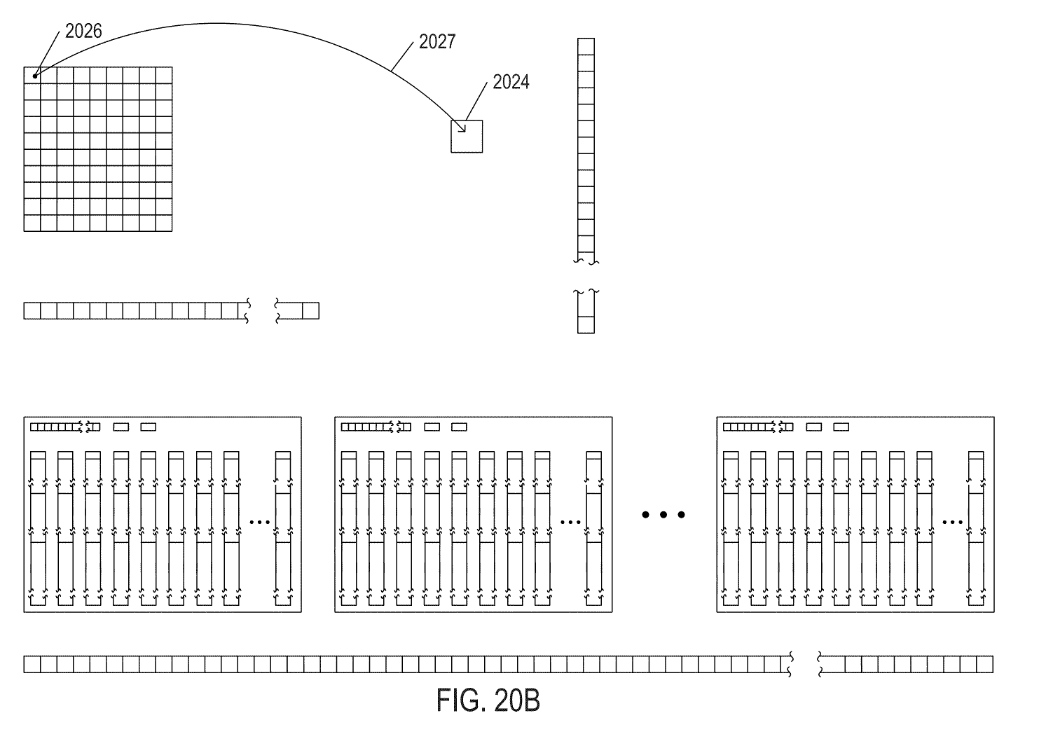

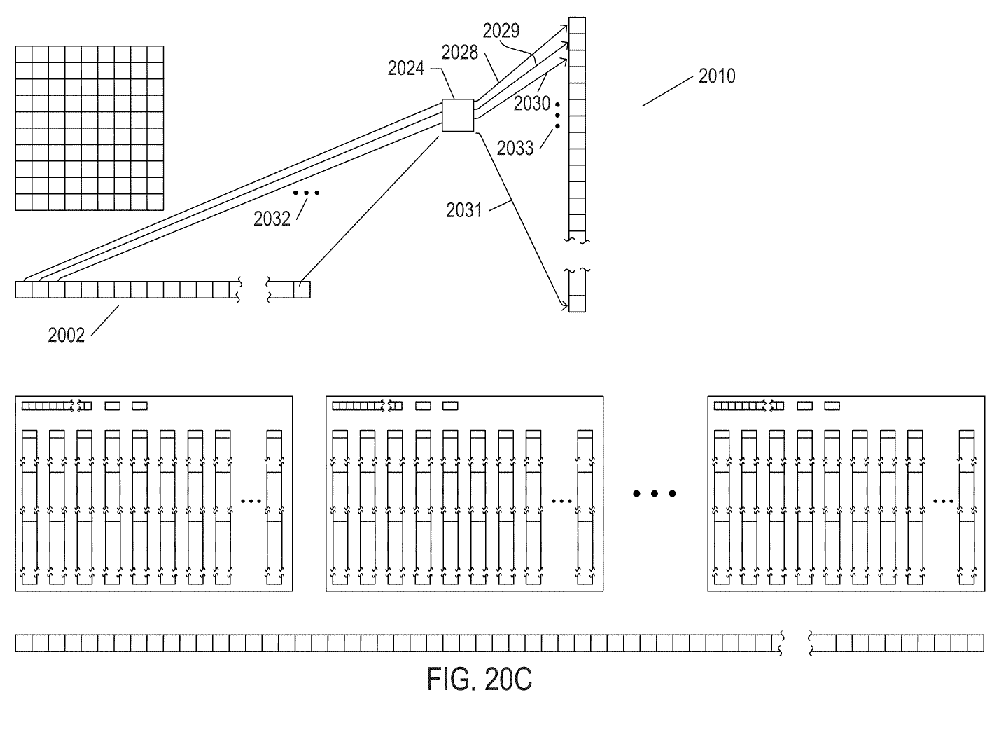

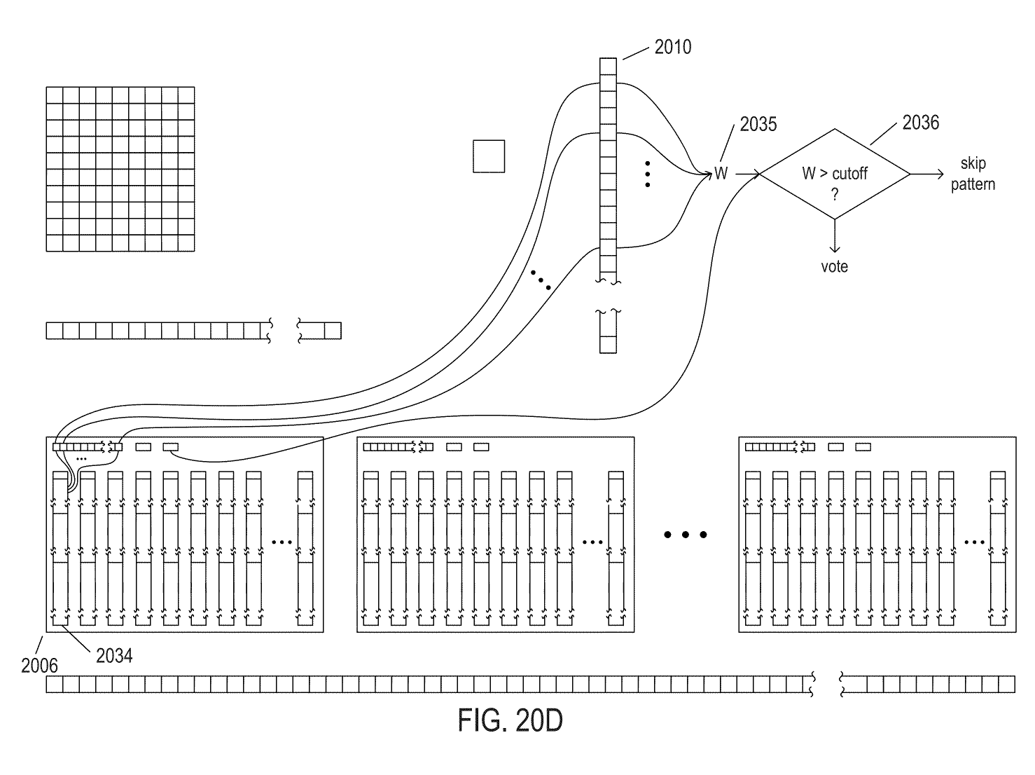

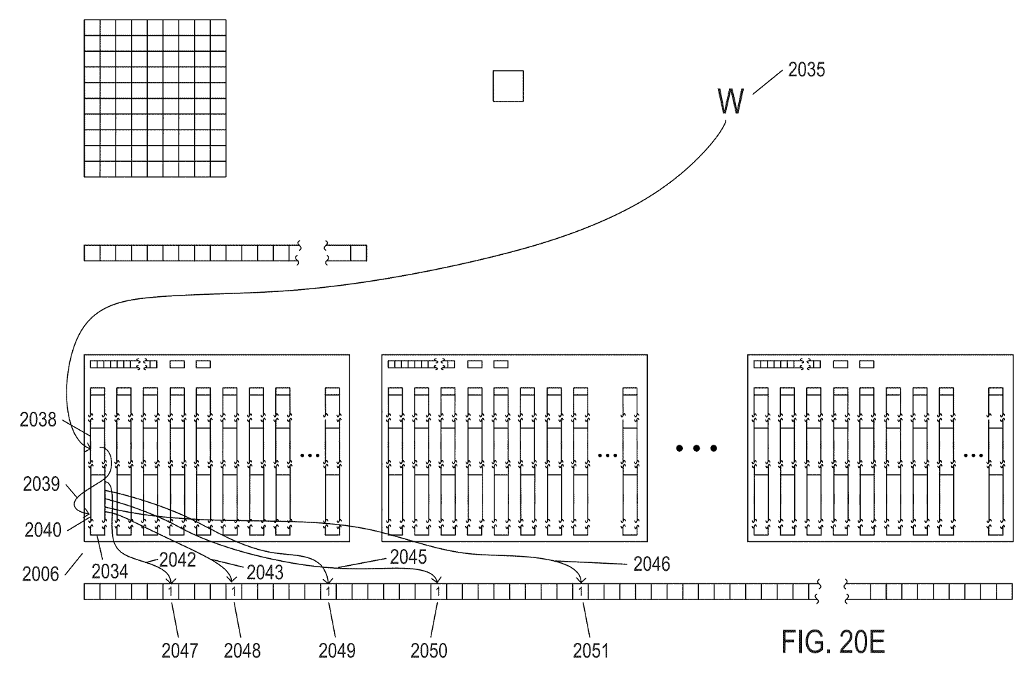

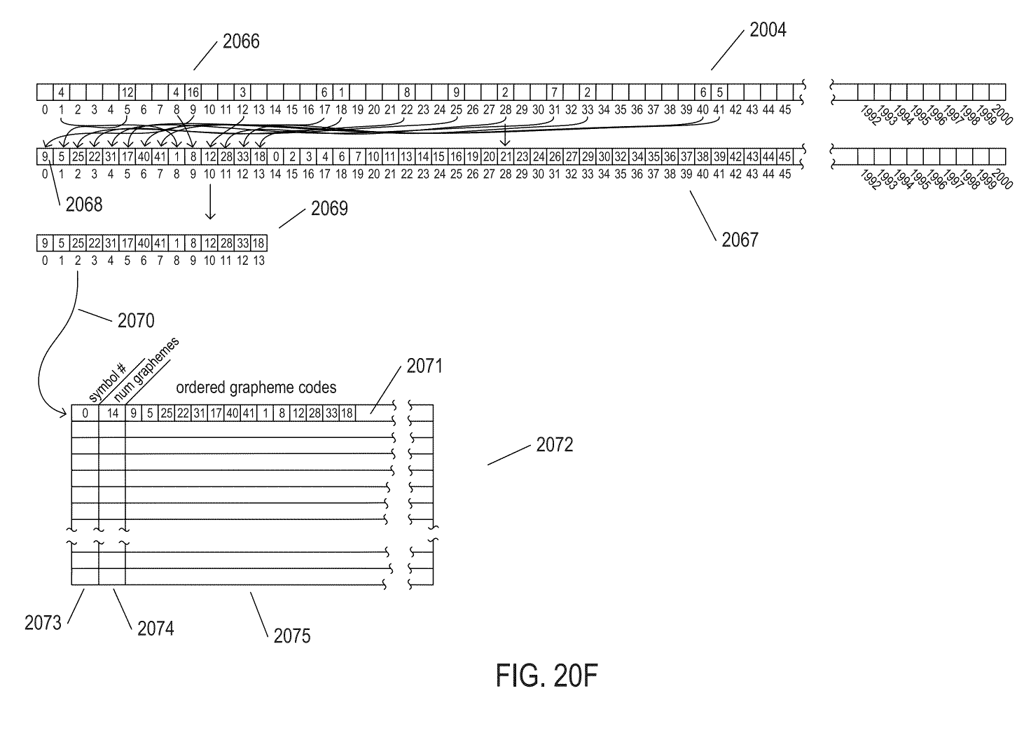

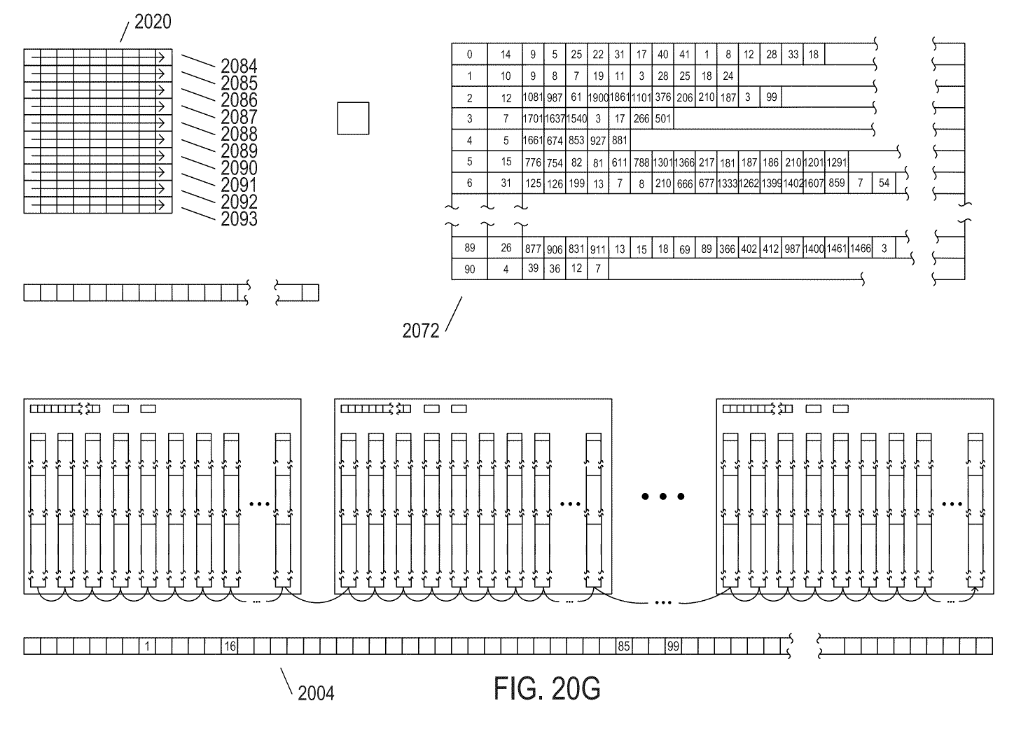

FIG. 20A illustrates the data and data structures involved in one example of multi-cluster OCR-based document processing. The same illustration conventions that are used in FIG. 20A are also used in FIGS. 20B-G, which follow. In FIG. 20A, many of the data structures illustrated in FIGS. 18 and 19A-G are again shown. These include the parameters array 2002, shown as array 1804 in FIG. 18, a votes array 2004, shows as votes array 1802 in FIG. 18, three cluster data structures 2006-2008, each identical to the cluster data structure 1806 shown in FIG. 18, and an array of computed parameter values 2010, similar to the array of computed parameter values 1924 shown in FIG. 19F. Note that the data structures are initialized to include appropriate values, with the votes array initialized to have all zero values. Each cluster data structure, such as cluster data structure 2006, includes a parameters array 2012, similar to the clusterParameters array 1808 shown in FIG. 18, a num value 2014 and a cutoff value 2016, identical to the num and cutoff values 1810 and 1812 shown within cluster 1806 in FIG. 18, and multiple pattern data structures, such as pattern data structure 2018, identical to pattern data structure 1902 in FIG. 19A. In addition, FIG. 20A shows a two-dimensional-array-like data structure 2020 that represents a scanned image of a document page that includes a grid-like array of symbol images, with each cell of the grid, such as cell 2022, representing a symbol image. Also, a currently considered symbol-image variable 2024 is shown in FIG. 20A.

The data structures shown in FIG. 20A may be implemented in many different ways, using many different programming languages and data-storage techniques. The data structures may include additional data and data substructures. For example, in one implementation, each pattern data structure in each cluster is references from a sorted array of cluster-data-structure references. In alternative implementations, each pattern data structure in each cluster is associated with a numerical order, allowing the pattern data structures to be traversed in a sorted order. In certain implementations, the pattern data structures may be included in a cluster data structure, while, in other implementations, the pattern data structures may be referenced from the cluster data structure. In many implementations, the data structures may be dynamically expanded or contracted, to adjust to changes in the types of OCR processing to which they are applied. Thus, although the term “array” is used to describe the votes data structure, the votes data structure may be implemented using data structures other than simple arrays that allow for array-like indexing of elements.

The text data structure 2020 represents a page of a document that is to be processed by the multi-cluster OCR-based document processing method in order to generate an equivalent, electronic document containing symbol codes from the input scanned document containing symbol images. The terms “document,” “page,” and “symbol image” may have different meanings in different contexts. In the current example, a document consists of multiple pages and each page includes multiple symbol images. Of course, the same or a similar multi-cluster OCR-based document processing method can be applied to a variety of different types of documents, whether or not containing pages, that include one or more symbol images.

In a first step, shown in FIG. 20B, an initial symbol image 2026 is read into, or referenced from, the currently considered symbol-image variable 2024, as represented by curved arrow 2027. Next, as illustrated in FIG. 20C, each parameter-computing function or routine included in, or referenced from, the parameters array 2002 is applied to the currently considered symbol image stored in, or referenced from, variable 2024 to generate corresponding parameter values stored in the array of computed parameter values 2010, as represented by arrows 2028-2031 and ellipses 2032-2033. Thus, the array of computed parameter values 2010 includes, in one implementation, numeric parameter values, corresponding to each of the parameters represented by functions or references to functions in parameter array 2002, computed with respect to a currently considered symbol image. Computation of parameter values is previously discussed with reference to FIGS. 19C-D.

Next, as shown in FIG. 20D, the first pattern data structure 2034 of the first cluster data structure 2006 is selected and the parameter values associated with the first pattern data structure are used, together with corresponding parameter values in the array of computed parameter values 2010 to computer a weight W 2035, as previously discussed above with reference to FIG. 19F. Note that the cluster-data-structure parameter array (2012 in FIG. 20A) is used to index the array of computed parameter values. As discussed above with reference to FIG. 19G, the computed weight is then compared with the cutoff value (2016 in FIG. 20A) 2036 to determine whether or not the first pattern data structure 2034 in the first cluster data structure 2006 can vote for graphemes, as discussed above with reference to FIG. 19H. In the current example, as shown in FIG. 20E, the computed weight 2035 is below the cutoff value, resulting in accumulation of votes in the votes array 2024 produced from the first pattern data structure 2034 in the first cluster data structure 2006. As discussed previously with reference to FIG. 19H, the computed weight 2035 is used as an index into a set of indices 2038 within the first pattern data structure 2034 and the contents of a selected member of the indices is used 2039 as an index into a grapheme-code-portion of the first pattern data structure 2040. Votes are generated for all graphemes corresponding to grapheme codes in the grapheme-code portion of the first pattern data structure from the first grapheme code down to the grapheme code indexed by the index selected from the indices portion of the pattern data structure. In FIG. 20E, the votes produced from the first pattern data structure 2034 within the first cluster data structure 2006 are represented by curved arrows 2042-2046. The blank values in the votes array (2004 in FIG. 20A) represent 0 values. The initial voting corresponding to the first pattern data structure 2034 in the first cluster data structure 2006 therefore increments the cumulative vote values 2047-2051 from 0 to 1 within the votes array for those graphemes for which corresponding grapheme codes are selected from the first pattern data structure. In alternative implementations, a vote may involve adding a number other than 1 to the value contained in the votes array.

The same process is repeated for each successive pattern data structure within the first cluster data structure, with any votes generated from the remaining pattern data structures accumulated in the votes array 2004. Then, the first pattern data structure in the second cluster data structure is selected and the steps illustrated in FIGS. 20D-E are carried out for this first pattern data structure in the second cluster data structure. It should be noted that the parameters referenced from the parameters array in each cluster, such as parameters array 2012 in cluster 2006, may differ from the parameters referenced from other clusters. In other words, each cluster data structure includes a parameters array that may reference a unique set of parameters associated with the cluster. There may be no, some, or substantial overlap between the parameters referenced from one cluster and the parameters referenced from another cluster. Each cluster represents a specialized recognition machine for families or sets of similar symbols. Because the different families or sets of symbols are best recognized using different corresponding sets of parameters, each cluster includes a parameters array to reference the particular parameters in the global parameters array (2002 in FIG. 20A) used by the cluster to recognize symbols of the family or set of symbols which the cluster is particularly designed to recognize. In addition, each cluster may employ a different number of pattern data structures, and, like the parameters referenced from clusters, there may be no, some, or substantial overlap between the parameter data structures referenced from one cluster and the parameter data structures referenced from another cluster. Processing continues with respect to each successive pattern data structure in the second cluster data structure and all additional cluster data structures including the final cluster data structure. All of the votes generated from the pattern data structures are accumulated in votes array 2004. This constitutes processing of the first symbol image selected from the text page 2020.

Next, as shown in FIG. 20F, the votes accumulated in the votes array for the first symbol image selected from the text page are used to prepare a sorted list of grapheme codes corresponding to the graphemes most frequently matched to the symbol image in the process discussed above with reference to FIGS. 20A-E, as indicated by the accumulated votes for the grapheme codes in the votes array. In FIG. 20F, the votes array 2004 is shown at the top of the figure. Each cell in the votes array contains a number of votes, and the cells are indexed by grapheme code. The votes and grapheme code indexes are then sorted, in descending vote-number order, to produce a sorted array 2067 in which each cell contains a grapheme code and the indices are monotonically increasing, from left to right, to indicate the order of the grapheme codes with respect to the votes which the grapheme codes received during the processing described in FIGS. 20A-E. For example, the greatest number of votes, 16, was received by grapheme code “9” 2066, and therefore the grapheme code “9” appears in the first entry 2068 of the sorted array of grapheme codes 2067. Next, the sorted array 2067 is truncated to produce a truncated grapheme-code sorted array 2069. The truncated grapheme-code sorted array includes a sorted list of grapheme codes that received votes in the process discussed above with reference to FIGS. 20A-E. In the process discussed with reference to FIGS. 20A-E, only 14 grapheme codes received votes and, therefore, the truncated grapheme-code array 2069 includes only 14 entries. These are the first 14 entries in sorted grapheme-code array 2067. The remaining entries in the sorted grapheme-code array 2067, following the fourteenth entry with index 13, include the grapheme codes for which no votes were received. Then, as indicated by curved arrow 2070, the truncated grapheme-code array is included in a first entry 2071 of a processed symbol image table 2072. Each entry of the processed symbol image table includes a field indicating the number or order of the symbol within the text data structure (2020 in FIG. 20A), represented by a first column 2073, a field that contains a numeric indication of the number of grapheme codes that received votes when the symbol was processed, represented by a second column 2074 in the processed symbol image table, and the truncated grapheme-code sorted array, represented by a third column 2075 in the processed symbol image table 2072.

In the implementation currently discussed, the truncated grapheme-code sorted arrays for the symbol images are accumulated in the processed symbol image table for each document page. The truncated grapheme-code sorted arrays are then employed, in a second phase, to transform the symbol images within a document page into symbols included within a processed document page. The truncated grapheme-code sorted array represents the result of initial processing, which identifies a set of candidate grapheme codes most likely related to each symbol image within the image of a page of a document. In the currently described implementation, all grapheme codes that received votes are included in each truncated grapheme-code sorted arrays. In alternative implementations, only those grapheme codes with a number of votes above a threshold are included in each truncated grapheme-code sorted array.

Once the first symbol image extracted from the document page has been processed, and an entry for the symbol image entered into the processed symbol image table, the second symbol image 2078 is then selected from the text data structure (2020 in FIG. 20A) and placed into symbol image variable 2024, and parameter values are computed for the next symbol and stored in the array of computed parameter values. Then, the second symbol image is processed to produce a new set of accumulated votes in the votes array 2004 for the second symbol image. The accumulated votes for the second symbol image 2004 are sorted by the number of votes to produce a sorted grapheme-code array. The sorted grapheme-code array is then truncated to produce a truncated grapheme-code sorted array which is included in a second entry in the processed symbol image table.

As shown in FIG. 20G, each symbol image in the text document 2020 is successively processed by the set steps discussed above with reference to FIGS. 20A-F, as indicated by arrows 2084-2093, to accumulate votes in the votes array 2004 for each symbol image. The accumulated votes for each symbol image are then used, in turn, to generate truncated grapheme-code sorted arrays for each of the symbol images that are included in entries for the symbol images in the processed symbol image table 2072. As a result of the cluster-based processing of symbol images in the text document, a processed symbol image table 2072 is produced which contains an entry for each symbol image in the text document. Each entry of the processed symbol image table represents an initial set of potentially matching graphemes for the symbol image. The set of potentially matching graphemes appears, in the truncated grapheme-code sorted array, in decreasing accumulated-vote order, so that the grapheme codes that received the most votes appear first in the truncated grapheme-code sorted array. A set of potentially matching grapheme codes, represented by a truncated grapheme-code sorted array, can then be used by additional character-recognition logic to determine a best symbol code for the symbol image from which the truncated grapheme-code sorted array was generated by the process described above with reference to FIGS. 20A-O.

### Short-Circuiting Second-Phase Processing for Non-Symbol-Containing Symbol Images

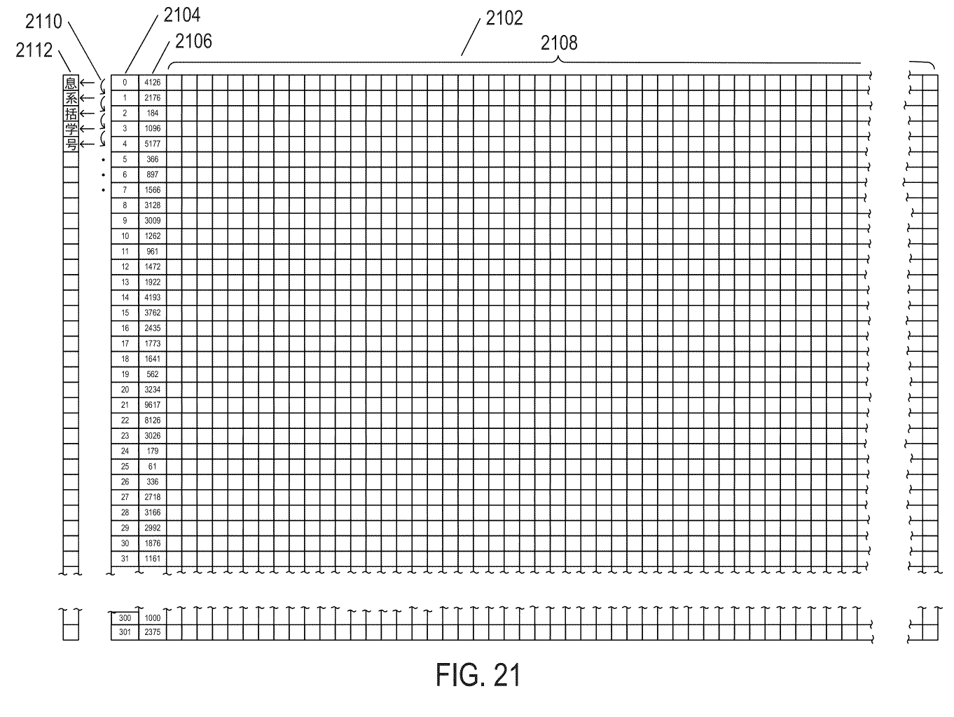

FIG. 21 illustrates a second phase of the OCR methods that associate symbol codes with symbol images. FIG. 21 shows a large processed symbol image table 2102 similar to the processed symbol image table 2072 shown in FIG. 20G. Each row in the table includes an indication of a symbol image within a document page or other text-containing image 2104, an integer representing the number of candidate graphemes identified for the symbol image 2106, and a generally very long list of candidate graphemes in best-matching to least-matching sorted order 2108. The second phase of document processing is shown, in FIG. 21, by the curved arrows, such as curved arrow 2110 and by the column 2112 of recognized characters corresponding to the symbol images. In the second phase of processing, the symbol image represented by the identifier in the first column 2104 of the processed symbol image table is compared with the candidate graphemes listed within the row of the processed symbol image table 2108 and a best-matching grapheme is selected from the candidate graphemes as the symbol that corresponds to the symbol image. Thus, during the second phase of document processing, as indicated by curved arrows, such as curved arrow 2110, each successive row of the processed symbol image table is processed to generate a corresponding symbol, or symbol code, stored in the column of symbol codes or symbols 2112 that represents the result of the symbol-image-to-symbol-code OCR methods and systems. Subsequently, the result symbols or symbol codes 2112 are used to generate an electronic document equivalent to the original scanned-document image or other text-containing image to which the OCR methods and systems are applied. It should be noted that, in many cases, there may be a very large number of candidate graphemes identified for any particular symbol image.

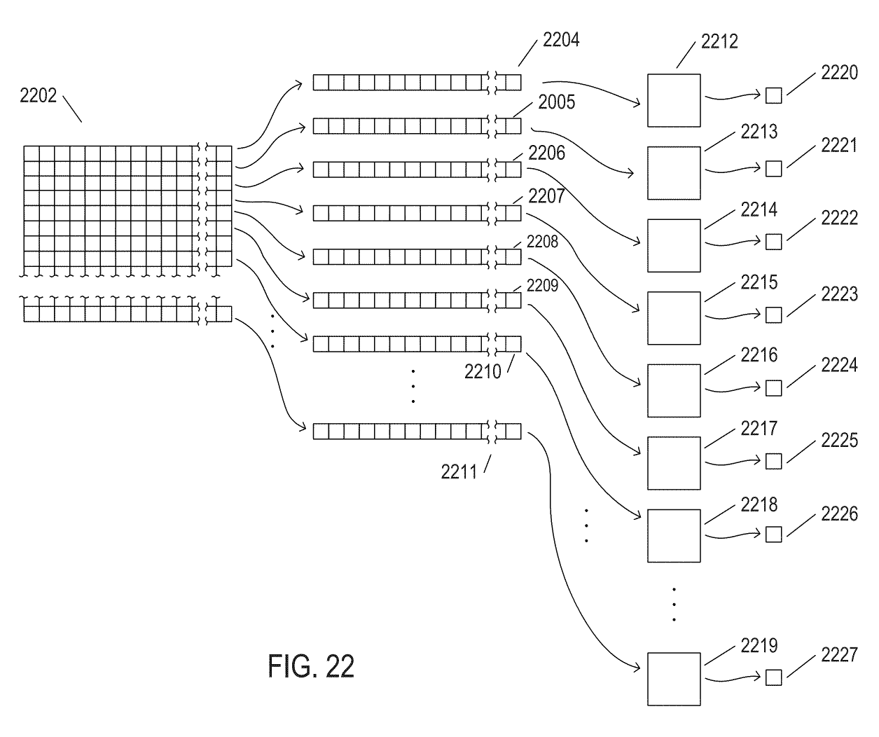

FIG. 22 illustrates one approach to parallelizing second-phase processing of symbol images with respect to candidate graphemes. As shown in FIG. 22, the processed symbol image table 2202 may be decomposed into individual rows 2204-2211 that may be each input to a processing entity 2212-2219, with the processing entity then generating a best-matching grapheme or symbol code 2220-2227. When there are fewer processing entities than rows in the processed symbol image table 2202, successive groups of rows may be distributed to the processing entities for parallel processing of each group of rows. The processing entities may be processors within multi-processor systems or distributed-computing systems, virtual processors within virtualized computer systems, processes that concurrently execute within computer systems and virtualized computer systems, hardware threads or operating-system threads, or other such computational entities. When there are computational resources available, in a given system, to process rows of the processed symbol image table in parallel, significant increase in OCR efficiency may be obtained by parallelizing the scanned-document-image processing methods.

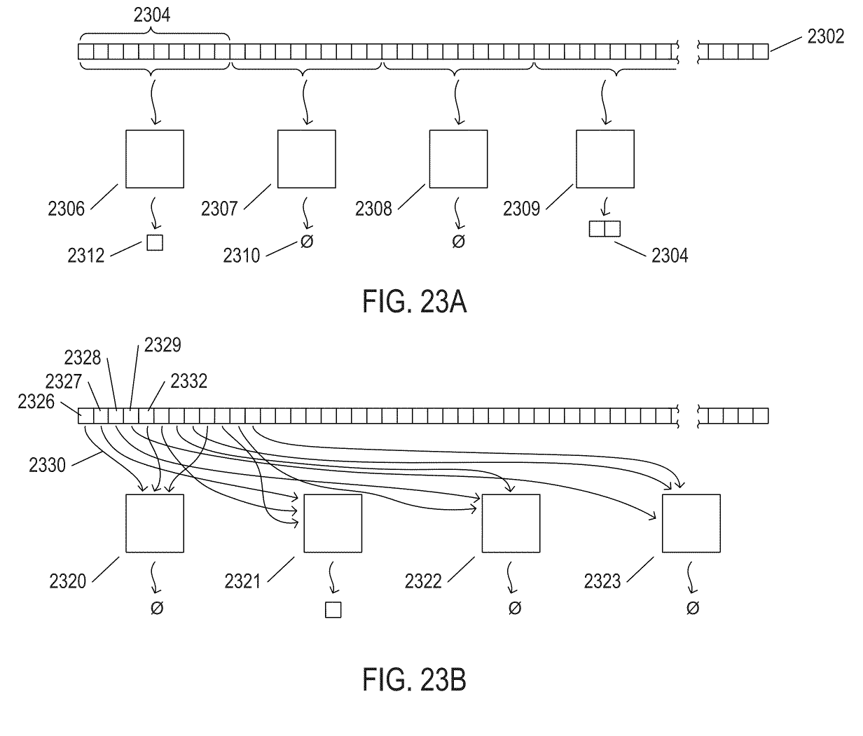

FIGS. 23A-B illustrate parallelizing processing of an individual symbol image with respect to the candidate graphemes identified for the symbol image. As shown in FIG. 23A, processing of a particular row of the processed symbol image table 2302 may also be parallelized, with successive blocks of candidate graphemes, such as block 2304, assigned to different processing entities 2306-2309, with the processing entity producing an indication of no suitable match 2310, a single best-matching candidate grapheme from the block of candidate graphemes 2312, or two or more potentially matching candidate graphemes 2314. In certain implementations, only a single best-matching candidate grapheme is produced for a given block of grapheme codes and, as successive blocks of grapheme codes are processed, a global best-matching grapheme is maintained and updated. In other implementations, the processing of the symbol image with respect to the candidate graphemes may generate a set of two or more grapheme codes that represent the best-matching candidate graphemes.

As shown in FIG. 23B, alternative methods for parallelizing processing of the symbol image can be implemented. In the case shown in FIG. 23B, there are four available processing entities 2320-2323. The first candidate grapheme 2326 is assigned to the first processing entity 2320, the second candidate grapheme 2327 is assigned to the second processing entity 2321, the third candidate grapheme 2328 is assigned to the third processing entity 2322, and the fourth candidate grapheme 2329 is assigned to the fourth processing entity 2323, as indicated by curved arrows, including curved arrow 2330. Then, this distribution process repeats again, starting with the fifth candidate grapheme 2332 which is assigned to the first processing entity 2320. The distribution of grapheme codes may proceed until each processing entity has been assigned a number of grapheme codes corresponding to a block size. Once the processing entities have processed the block of candidate graphemes assigned to them, the processing entities produce the same type of results produced by the processing entities in FIG. 23A. Then, a next set of blocks of grapheme codes is distributed to the processing entities for processing. Thus, the second phase of OCR processing may not only be parallelized by parallel processing of rows of the processed symbol image table, but may also be parallelized by parallel processing of blocks of candidate graphemes with respect to a single symbol image or, in other words, parallel processing of individual rows of the processed symbol image table.

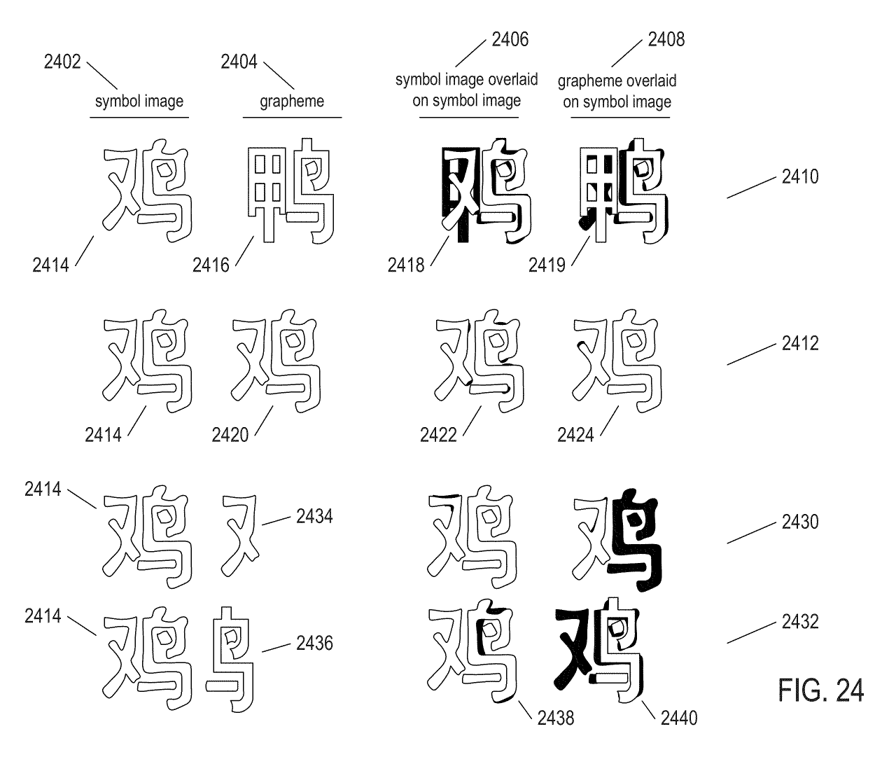

It should be noted that, in the second phase of document processing, in which symbol images are compared to candidate graphemes identified in the first phase of document processing for the symbol image, the comparisons are generally significantly more computationally complex than the comparisons employed during the first phase of document processing, as shown in FIG. 19C, in which case a weight is generated based on comparison of a relatively modest set of parameter values associated with a pattern and an equivalent set of parameter values computed for a particular symbol image. In the second phase of document processing, many additional parameters and types of parameters may be employed. Moreover, in addition to these parameter-value-based comparisons, in which the parameters are generated by relatively simple computations, such as those illustrated in FIGS. 8A-B and FIG. 12A, more complex image-based matching may be carried out. FIG. 24 illustrates some example image-based-matching methods. In FIG. 24, an example symbol image is shown in a first column 2402 and a candidate grapheme that is being evaluated with respect to the symbol image is shown in a second column 2404. In one technique, the symbol image may be overlaid over the image of the grapheme, as illustrated in the third column 2406 and, in a second step, an image of the grapheme may be overlaid over the symbol image, as shown in FIG. 2408. A metric may be computed, as one example, that combines the relative area of the grapheme image not covered by the symbol image and the relative area of the symbol image not covered by the grapheme image, indicated by shaded portions of the overlays shown in columns 2406 and 2408. These relative uncovered areas are, of course, computed after a reasonable rotation and translation space has been searched to produce the best possible coverings. In this case, as can be seen by comparing row 2410 to row 2412, the lower the relative uncovered portions in the overlays, the better the symbol image matches the grapheme. Symbol image 2414 does not closely correspond to the image of candidate grapheme 2416, as a result of which there are significant shaded portions in the two overlays 2418 and 2419 generated from symbol image 2414 and the representation of grapheme 2416. By contrast, symbol image 2414 very closely matches the representation of grapheme 2420, as a result of which there are only tiny uncovered portions in overlays 2422 and 2424. As shown in the final two rows of FIGS. 24, 2430 and 2432, the overlay technique can be used to recognize partial mappings and thus identify combinations of graphemes that together may produce a reasonable match for a particular symbol image. In these cases, a large disparity between the relative uncovered portions of the two overlays is indicative of a partial match and can be used to identify a partial match between a representation of a grapheme, such as the representation of grapheme 2434, and a symbol image, such as symbol image 2414. In similar fashion, the partial match between representation of grapheme 2436 and symbol image 2414 is recognized by disparity in the relative uncovered regions of the two overlays 2438 and 2440. By testing combinations of graphemes 2434 and 2436, a combined grapheme equivalent to grapheme 2420 can be generated to produce an almost exact match. These types of techniques are far more computationally intensive than the computation of simple parameter values used in generating the list of candidate graphemes in the first phase of document processing, discussed above.

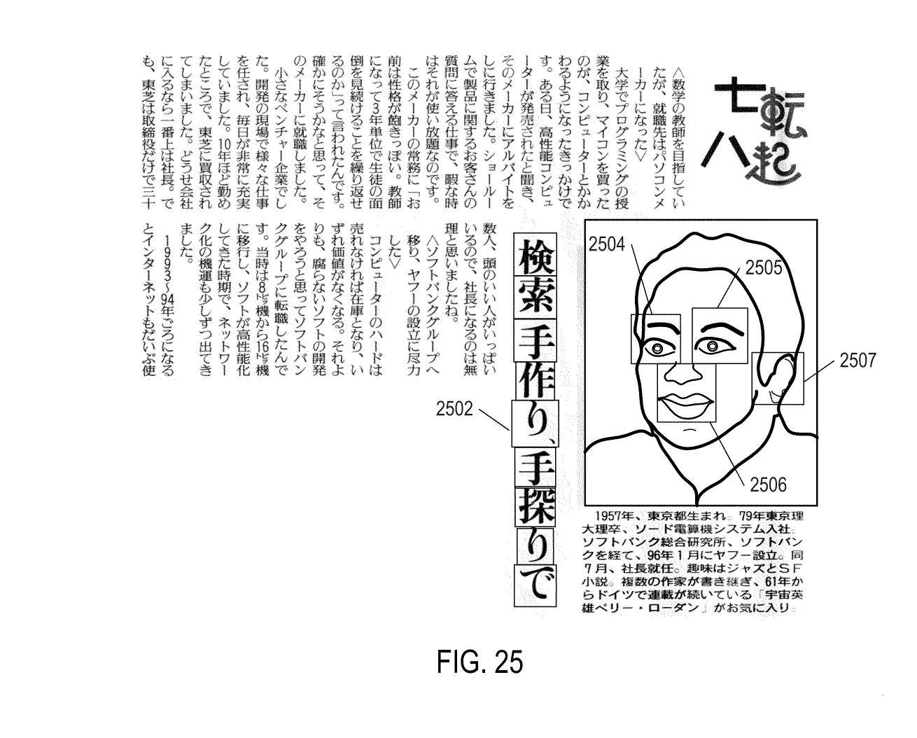

FIG. 25 illustrates a problem that may be encountered in scanned-document-image processing. FIG. 25 shows the same example scanned-document image as shown in FIGS. 1A-B. In FIG. 25, small rectangles, such as rectangle 2502, are drawn around certain of the characters to indicate areas of the image that have been designated as symbol images. While certain of these designated symbol images, such as symbol image 2502, may indeed contain the images of symbols, certain of the other designated symbol images, such as designated symbol images 2504-2507, have been erroneously selected. Rather than containing the images of symbols, these designated symbol images contain portions of a graphic image. The symbol images identified in the first phase of OCR processing are therefore perhaps better described as “probable symbol images,” since they are generally, but not necessarily always, images of symbols. In most cases, the OCR symbol-image-to-symbol-code conversion processing will fail to generate a matching symbol for the non-symbol-containing symbol images such as designated symbol images 2504-2507 in FIG. 25. Of course, even were, by chance, the OCR processing to generate a matching symbol for a non-symbol-containing symbol image, the purportedly matching symbol would be a spurious match.

There are many problems associated with applying exhaustive second-phase symbol-image-recognition techniques to non-symbol-containing symbol images. First, in naïve implementations, a large amount of processing would be carried out to compare each of the candidate graphemes to the non-symbol-containing symbol image that would, in the end, result in a failure to match a candidate grapheme to the non-symbol-containing symbol image. Thus, the presence of non-symbol-containing symbol images in the set of symbol images generated from a scanned-document image can significantly decrease the efficiency of scanned-document image processing. More serious consequences may arise in various OCR implementations that use adaptive methods and layers of feedback to tune symbol-image recognition during processing of a particular scanned-document image. In these case, spurious results generated from non-symbol-containing symbol images may adversely impact the ability of the system to adaptively tune itself to more efficiently recognize symbols as a scanned-document image is being processed. The current document discloses OCR methods and systems that prevent or ameliorate the loss of efficiency and other detrimental effects of non-symbol-containing symbol images during the conversion of symbol images to symbol codes.

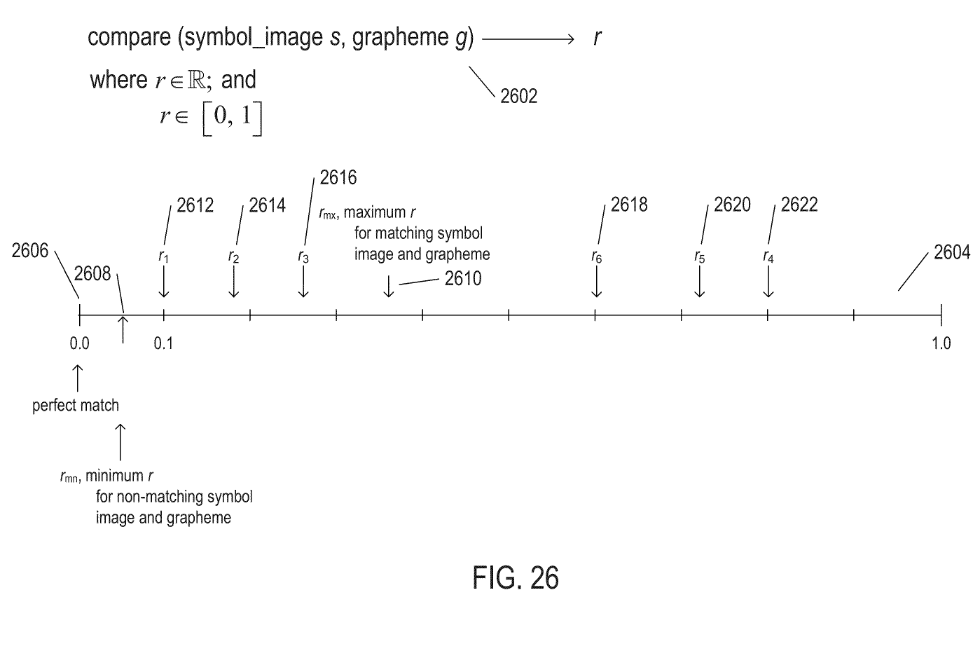

FIG. 26 illustrates a generalized comparison function that compares a symbol image to a candidate grapheme and that is used during second-phase scanned-document-image processing to evaluate the candidate graphemes associated with each symbol image in the processed symbol image table. The comparison function may employ any of a variety of different types of computed parameter values, such as those discussed above with reference to FIGS. 8A-B and FIG. 12A, but may also include additional image-comparison techniques and methods, such as those discussed above with reference to FIG. 24 as well as the pattern-matching-based, contour-based, and structure-based methods discussed above. The comparison function 2602 takes, as arguments, a symbol image s and a candidate grapheme g and produces, as a result, a real-valued result r. In many implementations, the value r falls within the range [0, 1]. Thus, the computed value r is similar to the weights computed in the first phase of processing and discussed with reference to FIG. 19C. However, any of many other conventions for r values may be employed, including conventions in which higher r values indicate closer matches.

FIG. 26 shows, as a linear plot, the range of the real-number line within which computed values r produced by the compare function fall 2604. As with the previously discussed weights, a perfect match between a candidate grapheme and symbol image produces the value r=0.0 (2606). In many cases, there is a slightly higher value rₘₙ 2608 that represents the minimum r for a symbol-image and non-matching-candidate-grapheme pair. The value rₘₙ depends, of course, on the particular symbol set and language as well as on the specific internal metrics and parameters values that are combined, by the comparison function, to produce the result value r. A generally significantly greater value, rₘₓ, 2610, is the maximum result value generated by the comparison function for a symbol image and a matching candidate grapheme. Again, rₘₓ depends on the particular comparison function and the symbol set and language. Whatever the actual numerical values of rₘₙ and rₘₓ, it is clear that, regardless of the symbol set and language and the specific comparison function, when the comparison function generates a value r for a symbol image and candidate grapheme below rₘₙ, then the candidate grapheme matches the symbol image and it is unlikely that another candidate grapheme, when compared to the symbol image, will produce a lower value of r. Similarly, when the comparison function generates a value r greater than rₘₓ for a particular symbol image and candidate grapheme, the candidate grapheme most likely does not match the symbol image. In FIG. 26, a number of additional r values are shown plotted along the portion of the real number line from 0.0 to 1.0, including r₁ 2612, r₂ 2614, r₃ 2616, r₆ 2618, r₅ 2620, and r₄ 2622. These additional r values will be discussed, below.

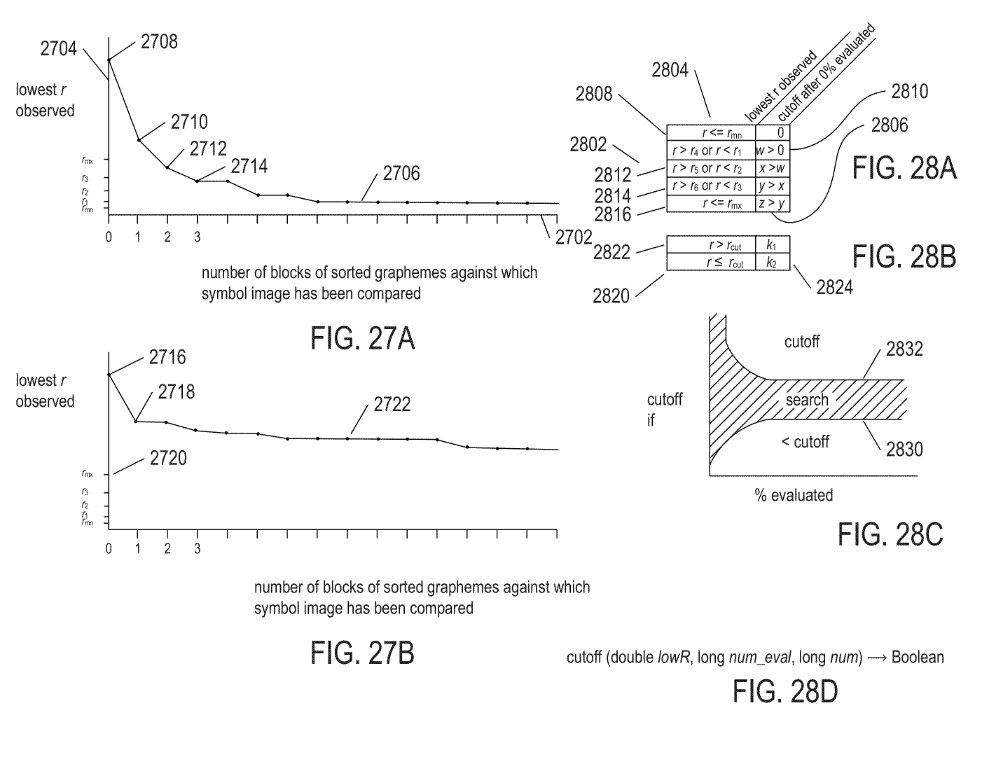

FIGS. 27A-B illustrate progress-to-recognition curves for symbol-image-to-symbol-code conversion by an OCR method and system. In FIG. 27A, a graph is provided with a horizontal axis 2702 representing the number of blocks of candidate symbols evaluated during an attempt to convert a symbol image to a symbol code and the vertical axis 2704 represents r values generated by a comparison function, such as that described above with reference to FIG. 26. Note that blocks can range in size from a single candidate symbol to 5, 10, or more candidate symbols. In particular, the curve 2706 plotted within the graph represents the lowest-observed r value for the comparison of candidate graphemes to a symbol image as successive blocks of candidate graphemes are processed. Initially, prior to the evaluation of any candidate graphemes, the lowest-observed r value is arbitrarily placed at the maximum r value of 1.0 (2708). The curve shown in FIG. 27A is a hypothetical curve for processing of a symbol-containing symbol image or, in other words, for a symbol image corresponding to a symbol of a language within which symbols are being recognized. As discussed above, the candidate graphemes are ordered in best-matching to least-matching order, so that, in general, OCR processing quickly finds relatively good matches in the initial blocks of candidate graphemes evaluated. Thus, the curve falls steeply once a first block of candidate graphemes has been evaluated, producing a reasonable r value 2710. The lowest-observed r value continues to decrease at an increasingly less-steep rate over the initial blocks of candidate graphemes, as shown by the lowest-observed r values 2712 and 2714 but then eventually tends to flatten out. For any particular symbol image, a wide variety of different specific progress-to-recognition curves may be observed. In many cases, for example, the curve would drop down to a very low value immediately, upon completion of processing of the first block of candidate graphemes, and then flatten out from that point onward, having found a perfect or near perfect match in the first block of candidate graphemes evaluated. However, on average, the progress-to-recognition curves have shapes similar to, or related to, the exponential-decay-shaped curve 2706 shown in FIG. 27A.

By contrast, FIG. 27B shows a progress-to-recognition curve for a non-symbol-containing symbol image. In this case, the curve drops initially, as represented by the line segment between the maximum r value 2716 and the first lowest-observed r value 2718 following evaluation of the first block of candidate graphemes, but then generally flattens more quickly to a significantly higher value than for the progress-to-recognition curve shown in FIG. 27A. In the general case, the curve never drops below rₘₓ 2720. This is not surprising since, for non-symbol-containing symbol images, it is quite unlikely that the OCR method and system can find a matching candidate grapheme. There are, of course, certain possible exceptions, when a non-character-containing portion of the image nonetheless contains a pattern of lines that coincidentally conform to the shape of a particular symbol. However, in the general case, progress-to-recognition curves for non-symbol-containing symbol images have a form similar to, or related to, the progress-to-recognition curve 2722 shown in FIG. 27B.

These characteristic differences in the progress-to-recognition curves for symbol-containing symbol images versus non-symbol-containing symbol images provides a basis for monitoring the progress to recognition during processing of a symbol image in order to determine, long before all of the candidate graphemes have been evaluated, whether the symbol image is likely a non-symbol-containing image, with a progress-to-recognition curve similar to curve 2722 in FIG. 27B, or whether the symbol image is a legitimate symbol-containing symbol image, in which case the monitored progress to recognition resembles the progress-to-recognition curve 2706 shown in FIG. 27A. For example, even by the time that three blocks of candidate graphemes have been evaluated, in the examples shown in FIGS. 27A-B, the early portions of the two progress-to-recognition curves would clearly distinguish the legitimate symbol-containing symbol image of FIG. 27A from the non-symbol-containing symbol image of FIG. 27B.

FIGS. 28A-D illustrate various implementations of a cutoff function that determines when to terminate processing in order to improve processing efficiency and avoid the potential disadvantages of processing a non-symbol-containing symbol image. FIG. 28A shows a table that contains pairs of r-value ranges and percentages of the total number of candidate graphemes evaluated during processing of the symbol image. For a given lowest-observed r value, during symbol-image processing, when the r value falls into a range defined in an entry within the first column 2804 of the table 2802 and when the percentage of the candidate graphemes already evaluated is greater than or equal to the percentage shown in the entry of the second column 2806 of the same row, then immediate termination of processing should occur. Termination of processing should occur, in general, when either it is clear that the symbol image is a non-symbol-containing symbol image or when it is unlikely that a match better than the currently observed best match between the symbol image and a candidate grapheme will be discovered by further processing. In other words, termination of processing occurs when progress monitoring determines that an identified, probable symbol image does not actually contain an image of a symbol or when the computational overhead for continued processing of candidate graphemes is not offset by a probability of finding a candidate grapheme that produces a comparison value with respect to the probable symbol image that indicates a closer match than an already evaluated candidate grapheme.

The first row of the table 2808 indicates that whenever the evaluation of a candidate grapheme with the symbol image produces an r value less than rₙₘ, then further processing should be terminated. As discussed above, it is unlikely that any other candidate grapheme would produce a lower r value. The second row 2810 of the table 2804 indicates that when the lowest-observed r value is greater than r₄ or less than r₁ and the percentage of candidate graphemes already evaluated is greater than or equal to co, then further processing should be terminated. When the lowest-observed r value is greater than r₄, as can be seen in FIG. 26, there is an indication that the progress-to-recognition curve belongs to the family of curves represented by curve 2722 in FIG. 27B rather than to the family of curves represented by curve 2706 in FIG. 27A. When the lowest-observed r value is less than r₁, then, because the candidate graphemes are ordered in best-matching to poorest-matching order, it is unlikely that a better candidate grapheme will be discovered by further processing. Entries 2812 and 2814 represent a further narrowing of the range of lowest-observed r values that would justify continued processing. Finally, entry 2816 indicates that once a relatively large percentage of the candidate graphemes have been evaluated, and when the lowest-observed r value is less than or equal to rₘₓ, it is likely that the lowest-observed r value represents the lowest r value that would be obtained even were more candidate graphemes to be evaluated, particularly given that the candidate graphemes are sorted in best-matching to least-matching order.

FIG. 28B shows a smaller table 2820 with entries that represent a somewhat different approach to determining when to terminate symbol-image processing. In this case, there is a single cutoff value r_{cut}. The first entry of the table 2822 indicates that when the lowest-observed r value is greater than r_{cut}, and when kₗ percent of the candidate graphemes have already been evaluated, then further processing should be terminated since the progress-to-recognition curve would clearly fall in the family of curves represented by curve 2722 in FIG. 27B rather than the family of curves represented by curve 2706 in FIG. 27A. The second entry 2824 indicates that, when the lowest-observed r value is less than or equal to r_{cut} and when k₂ percent of the candidate graphemes have been evaluated, then it is unlikely that further processing will produce a better matching candidate grapheme.

FIG. 28C represents yet a different approach to cutoff determination. In this case, two continuous functions 2830 and 2832 are selected to generate two curves which define a region between the curves, shown cross-hatched in FIG. 28C, in which continued processing is justifiable when a point with coordinates defined by the lowest-observed r value following processing of a number of blocks of candidate graphemes and by the percentage of number of blocks of candidate graphemes already processed with respect to the total number of blocks falls within the cross-hatched search region. In other words, continuous functions may be used to determine, from a given lowest-observed r value and a given percentage of candidate graphemes already evaluated, whether or not further processing should be terminated.

Finally, as shown in FIG. 28D, all of the various particular approaches to determine whether or not to terminate processing of a symbol image as a result of monitoring the progress to recognition during processing of a symbol image can be encapsulated in a cutoff function that returns a Boolean value that receives, as arguments, the lowest r value currently observed in comparing the symbol image to a candidate grapheme, the number of candidate graphemes already evaluated, and the total number of candidate graphemes associated with the symbol image.

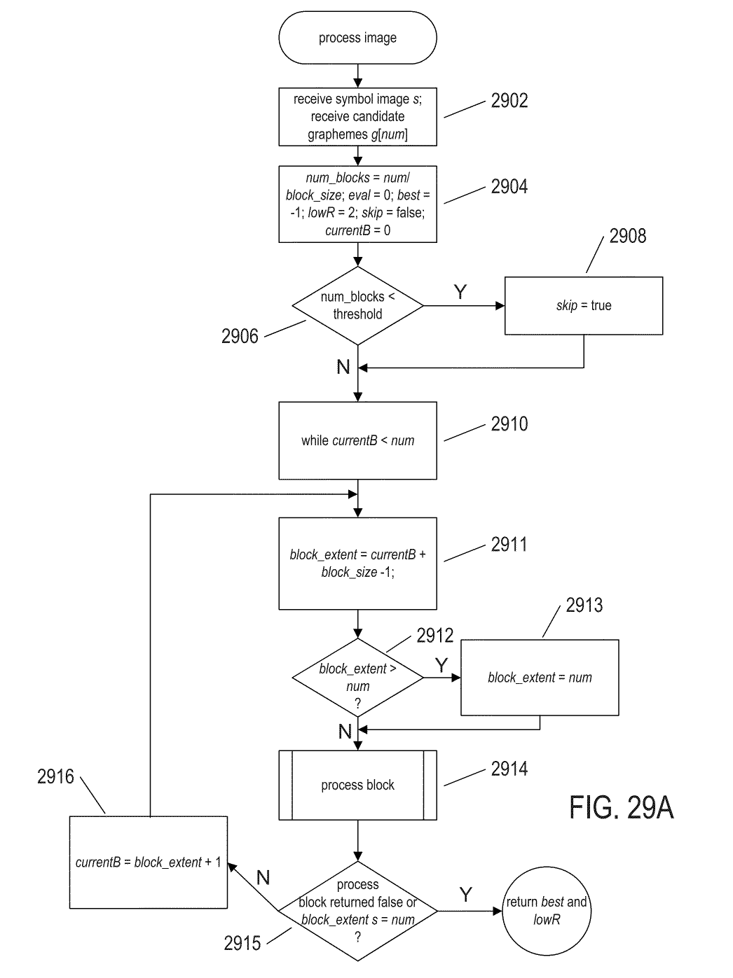

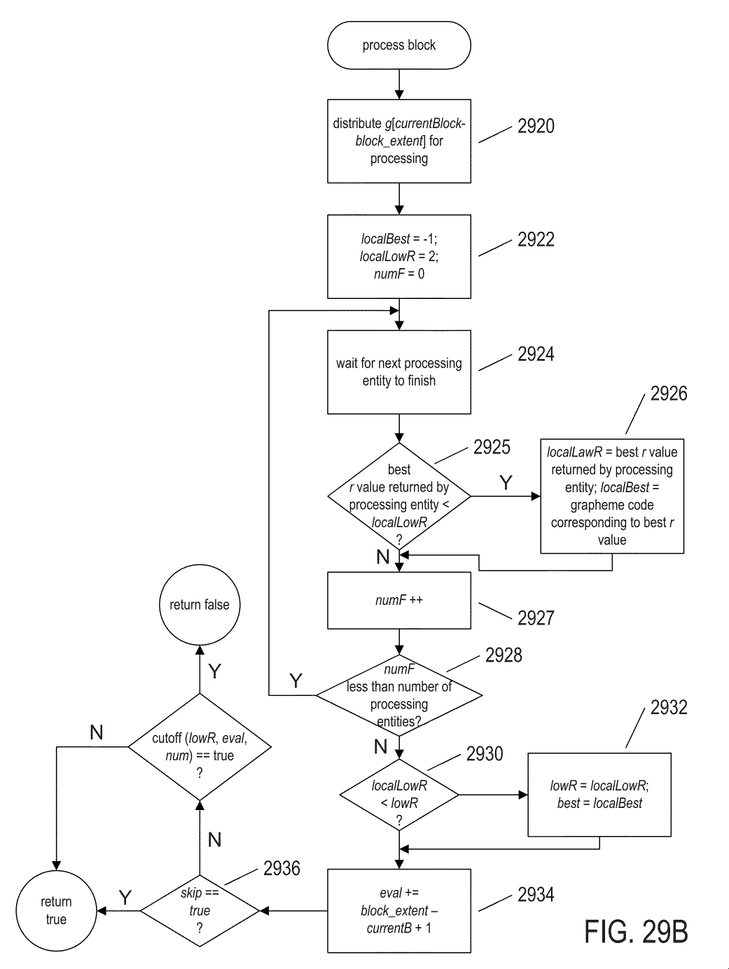

FIGS. 29A-B provide control-flow diagrams that illustrate use of a cutoff function, during the second phase of scanned-document-image processing, to terminate symbol-image processing prior to evaluation of all of the candidate graphemes associated with a symbol image. In the example shown in FIGS. 29A-B, it is assumed that the set of graphemes for the language of the symbols in a scanned-document image fully cover the symbols of the language. In other words, for any legitimate symbol of the language, there is at least one grapheme that, by itself, matches that symbol and corresponds to a symbol code that is associated with that symbol. There are implementations, for particular languages, in which, as discussed above with reference to FIG. 24, the recognition process may employ two or more graphemes that partially match a symbol image in order to construct a composite matching grapheme for the symbol, with composite graphemes that match symbols associated with symbol codes that can be assigned to the symbols. In such cases, as discussed below, the logic illustrated in FIGS. 29A-B can be slightly adjusted so that lowest-observed r values are computed based not only on the lowest r value observed for any single call to the comparison function but, instead, on those values as well as r values computed from composite graphemes.

FIG. 29A provides a control-flow diagram for a routine “process image” that carries out evaluation of the candidate graphemes associated with the symbol image in order to find a matching candidate grapheme from which a symbol code can be derived to represent the symbol contained in the symbol image. In step 2902, the routine “process image” receives a symbol image s as well as a set of candidate graphemes g identified for the symbol in the first phase of scanned-document-image processing. There are num candidate graphemes that have been identified for the symbol image s. Next, in step 2904, a local variable num_blocks is assigned to be the number of candidate graphemes num divided by the size of the blocks of candidate graphemes that are processed in each phase of parallel processing, represented by the constant block_size. Note that the size of the blocks can range from 1 up to the number of candidate graphemes num and that the corresponding number of blocks can range from the number of candidate graphemes num to 1. The local variable eval is assigned to be 0, the local variable best is assigned to −1, the local variable lowR is assigned to be 2, the local variable skip is assigned to be False, and the local variable currentB is assigned to be 0. When, as determined in step 2906, the computed number of blocks num_blocks is less than a threshold value, then, in step 2908, the local variable skip is set to true. When the number of blocks of candidate graphemes is less than some small threshold value, there is no point in monitoring progress to recognition or determining whether or not to prematurely terminate processing. Next, in the while-loop of steps 2910-2916, evaluation of the candidate graphemes g is carried out with respect to the symbol image s. In step 2911, the local variable block_extent is set to be the current value of currentB plus the constant block_size−1. Thus, the next block of candidate graphemes for evaluation begins with the index currentB and ends with the index block_extent when the candidate graphemes are considered to be members of a linear array. In the case that the local variable block_extent is assigned a value greater than num, as determined in step 2912, then block_extent is set to num in step 2913. In step 2914, the subroutine “process block” is called to carry out processing of the next block of candidate graphemes. In general, processing of this next block of candidate graphemes is carried out in a parallel fashion. Once the processing concludes and the subroutine “process block” returns, then, in the case that the subroutine “process block” returns a Boolean value False or in the case that local variable block_extent has the value num, as determined in step 2915, the routine “process image” returns the current values of the local variables best and lowR which represent the best-matching candidate grapheme and corresponding r value for a comparison of that candidate grapheme with the symbol image, respectively. Otherwise, currentB is set to the current value of block_extent+1, in step 2916, and control flows back to step 2911 for another iteration of the while-loop of steps 2910-2916.

FIG. 29B provides a control-flow diagram for the subroutine “process block” called in step 2914 of FIG. 29A. In step 2920, the subroutine “process block” distributes the current block of candidate graphemes to one or more computational entities for processing. In step 2922, the subroutine “process block” sets a local variable localBest to −1, sets a local variable localLowR to 2, and sets a local variable numF to 0. Then, in the loop comprising steps 2924-2927, the subroutine “process block” waits for a next processing entity to finish processing its portion of the block of candidate graphemes and, when a next processing entity finishes, determines, in step 2925, whether the best r value returned by the processing entity is less than the current value of the local variable localLowR. When the best r value is lower, then, in step 2926, the local variable localLowR is set to the best r value returned by the processing entity and the local variable localBest is set to the grapheme code corresponding to the best r value returned by the processing entity. In step 2927, the local variable numF is incremented. When the value stored in the local variable numF is less than the number of processing entities, as determined in step 2928, control returns to step 2924 to wait for a next processing entity to finish processing. Once all the processing entities have finished, when the current value stored in the variable localLowR is less than the value in the variable lowR, as determined in step 2930, then the variable lowR is set to the value currently stored in the variable localLowR and the variable best is set to the value currently stored in the local localBest, in step 2932. Thus, lowR reflects the lowest r value observed by any processing entity up to the current point in the time and the variable best stores the grapheme code from which this lowest r value is generated by a comparison of the candidate grapheme with the symbol image s. In step 2934, the size of the just-processed block of candidate graphemes is added to the variable eval. When the variable skip is true, as determined in step 2936, then the subroutine “process block” returns the value True. Otherwise, the subroutine “process block” calls the cutoff function, discussed above with reference to FIG. 28D, to determine whether or not processing of symbol image s should continue. When the cutoff function returns a value True, then the subroutine “process block” returns the value False. Otherwise, the subroutine “process block” returns the value True.

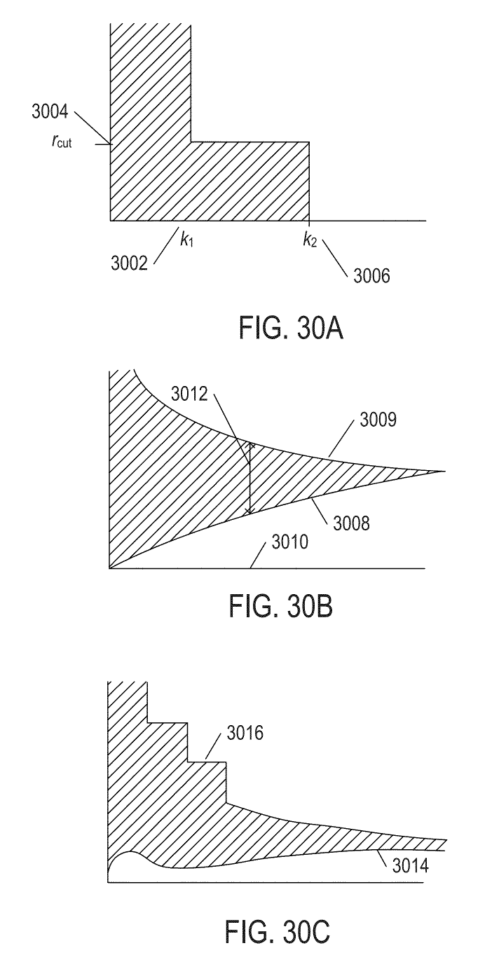

FIGS. 30A-C illustrate various different types of cutoff strategies. All of these figures use the same illustration conventions as used in FIG. 28C. The horizontal axis represents the percent of candidate graphemes already evaluated during processing of a symbol image and the vertical axis represents the lowest-observed r value. FIG. 30A illustrates the strategy previously discussed with reference to FIG. 28B. Once k₁ percent of the candidate graphemes have been evaluated 3002 and when the lowest-observed r value is greater than r_{cut} 3004, then processing is terminated. When k₂ percent of the candidate graphemes have been evaluated and the lowest-observed r value is less than r_{cut}, 3006, then processing is also terminated.

In the strategy shown in FIG. 30B, two continuous curves 3008 and 3009 define the region of lowest-observed-r-value/percent-evaluated pairs that warrant further OCR processing. In this case, the range of lowest-observed r values, for any percent of candidate-grapheme evaluation, such as the percent represented by point 3010 corresponding to the range of r values represented by the double-headed arrow 3012, continuously decreases as more and more blocks of candidate graphemes are evaluated.

FIG. 30C shows yet an alternative strategy that employs both a continuous function 3014 and a partially stepped function 3016 to define the lowest-observed-r-value/percent-evaluated points within the region that represents a continued need for additional OCR processing.

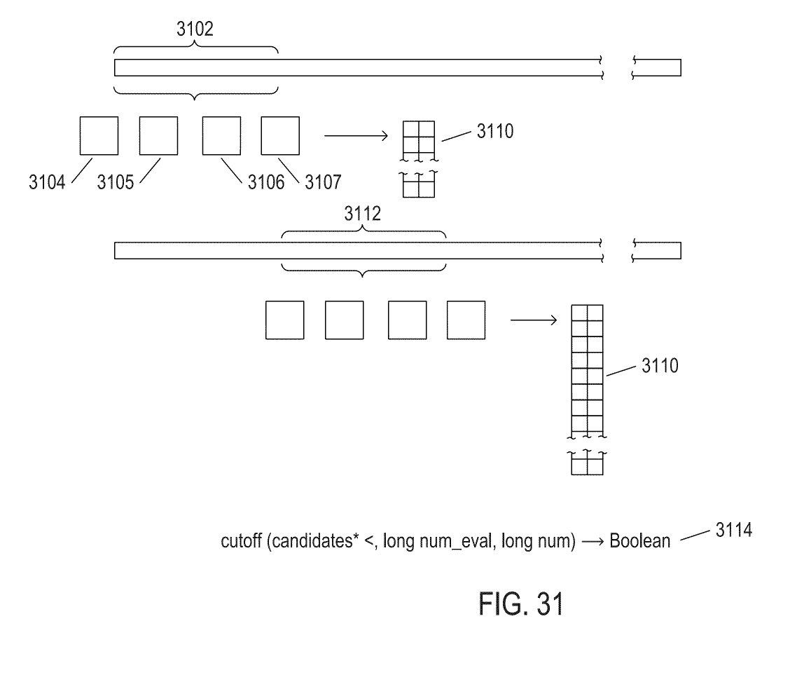

FIG. 31 illustrates an approach to second-phase processing suitable for implementations in which composite graphemes may be used for symbol-image recognition. In these cases, when a block 3102 of candidate graphemes are distributed to multiple processing entities 3104-3107 for processing, the processing entities return a list of promising candidate graphemes and associated r values 3110. As processing continues with a subsequent block of candidate graphemes 3112, the list of promising candidate graphemes may grow after processing of each block of candidate graphemes, and a cutoff function 3114 that receives, as arguments, a pointer to the list of promising candidate graphemes as well as the number of candidate graphemes already evaluated and the total number of candidate graphemes produces a Boolean value indicating whether or not to terminate processing. In this case, the current lowest-observed r values need to include the lowest-observed r value from any direct comparison of the symbol image with a candidate grapheme as well as the lowest r value observed for all possible composite graphemes composed from the promising candidate graphemes 3110.

There are a variety of alternative comparison functions and cutoff functions that can be implemented in order to carry out many different possible scanned-document-image-processing early-termination strategies. Rather than simply monitoring the lowest-observed r value, an OCR system may also monitor the rate of change of the lowest-observed r value over time as an alternative or additional way to compare current progress to recognition with the family of curves that represent progress-to-recognition curves characteristic for processing of non-symbol-containing symbol images in order to detect and terminate processing of non-symbol-containing symbol images. Many other characteristics and metrics can be used to make this determination. In addition to early termination as a result of a low probability of finding a better match and due to a low probability of finding any match, other considerations may be incorporated into alternative cutoff functions.

Although the present invention has been described in terms of particular embodiments, it is not intended that the invention be limited to these embodiments. Modifications within the spirit of the invention will be apparent to those skilled in the art. For example, any of many different implementation and design parameters can be varied, including operating system, programming language, control structures, data structures, modular organization, and other such parameters to produce many different possible alternative implementations of the early-termination method that may be incorporated into OCR processing systems. As discussed above, there are many alternative approaches to designing and implementing scoring functions and cutoff functions. In addition, the early termination method may be applied to a variety of different OCR implementations which feature different types of processing strategies, parallelization methodologies, and other such differences.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An optical-symbol-recognition system comprising:
one or more processors;
one or more memories;
one of more data-storage devices; and
computer instructions, stored in one or more of the one or more data-storage devices that, when executed by one or more of the one or more processors, control the optical-symbol-recognition system to process a text-containing scanned image of a document by
identifying probable symbol images in the text-containing scanned image of the document,
for each identified probable symbol image, identifying and associating with the probable symbol image, in a first processing phase, an ordered set of candidate graphemes, and
for each identified probable symbol image, in a second processing phase, evaluating candidate graphemes associated with the probable symbol image in the first processing phase while monitoring progress towards identifying a matching candidate grapheme for the probable symbol image and terminating evaluation of candidate graphemes when the progress monitoring determines that the probable symbol image does not contain an image of a symbol.

2. The optical-symbol-recognition system of claim 1 further including terminating evaluation of candidate graphemes when the progress monitoring determines that a computational cost of continuing evaluation of candidate graphemes is not offset by a probability of finding a candidate grapheme that produces a comparison value with respect to the probable symbol image that indicates a closer match than an already evaluated candidate grapheme.

3. The optical-symbol-recognition system of claim 1 wherein monitoring progress towards identifying a matching candidate grapheme further comprises:
following evaluation of each successive group of one or more candidate graphemes with respect to the probable symbol image, updating an indication of the best observed candidate grapheme and an indication of a comparison value produced by comparing the best observed candidate grapheme to the probable symbol image, the best observed candidate grapheme comprising the candidate grapheme that, when compared to the probable symbol image, produced the comparison value that indicates that the best observed candidate grapheme matches the symbol image at least as closely as any other candidate grapheme evaluated with respect to the probable symbol image.

4. The optical-symbol-recognition system of claim 1 wherein evaluating a candidate grapheme associated with the probable symbol image further comprises:
applying a comparison function to the probable symbol image and the candidate grapheme that produces a comparison value that falls within a range of possible comparison values from a first comparison value to a final comparison value.

5. The optical-symbol-recognition system of claim 4
wherein the first comparison value indicates that the probable symbol image exactly matches the candidate grapheme;
wherein the final comparison value indicates that the probable symbol image and the candidate grapheme are unrelated to one another; and
wherein comparison values between the first comparison value and the final comparison value indicate intermediate degrees of matching of the symbol image to the candidate grapheme, with the intermediate levels of matching ordered from best-matching to least matching in the range from the first comparison value to the final comparison value.

6. The optical-symbol-recognition system of claim 4 wherein the comparison function produces a comparison value by a comparison method, including one or more of:
computing one or more parameter values and metric values for the probable symbol image and the candidate grapheme and generating the comparison value based on computed differences between the computed values for each parameter and metric;
computing the comparison value as a degree to which the probable symbol image, following rotation and scaling, matches the candidate grapheme;
computing one or more parameter values and metric values for a contour of the probable symbol image and a contour of the candidate grapheme and generating the comparison value based on computed differences between the computed values for each parameter and metric;
computing the comparison value as a degree to which the contour of the probable symbol image, following rotation and scaling, matches the contour of the candidate grapheme;
computing one or more parameter values and metric values for a structure of the probable symbol image and a structure of the candidate grapheme and generating the comparison value based on computed differences between the computed values for each parameter and metric; and
computing the comparison value as a degree to which the structure of the probable symbol image, following rotation and scaling, matches the structure of the candidate grapheme.

7. The optical-symbol-recognition system of claim 4 wherein monitoring progress towards identifying a matching candidate grapheme further comprises:
for each successive group of one or more candidate graphemes,
for each candidate grapheme in the group of one or more candidate graphemes, applying the comparison function to the candidate grapheme and the probable symbol image; and
when a comparison value produced from a local best candidate grapheme of the group of candidate graphemes is closer to the first comparison value than a stored best comparison value,
updating the stored best comparison value to store the comparison value produced from the local best candidate grapheme, and
updating a stored indication of the best candidate grapheme to indicate the local best candidate grapheme.

8. The optical-symbol-recognition system of claim 7 wherein terminating evaluation of candidate graphemes when the progress monitoring determines that the probable symbol image does not contain an image of a symbol further comprises:
computing a completion value as one of
a percentage of the number of candidate graphemes associated with the probable symbol image already evaluated with respect to the probable symbol image, or
a number of candidate graphemes already evaluated with respect to the probable symbol image;
computing a progress value as one of
the stored best global comparison value,
a difference between the value currently stored in the stored best comparison value and a previous value stored in stored best comparison value, or
a combination of the stored best comparison value and the difference between the value currently stored in the stored best comparison value and the previous value stored in stored best comparison value; and
evaluating the computed completion value and the progress value with respect to evaluation criteria to determine whether or not to terminate evaluation of candidate graphemes.

9. The optical-symbol-recognition system of claim 8 wherein the evaluation criteria further comprises one of:
a cutoff comparison value, with the evaluation of candidate graphemes terminated when the completion value is greater than a first threshold value and the progress value is greater than the cutoff comparison value; and
a boundary function, with the evaluation of candidate graphemes terminated when a point described by a coordinate composed of the progress value and the completion value falls above the boundary function.

10. The optical-symbol-recognition system of claim 8 wherein evaluation of candidate graphemes is terminated when the progress monitoring determines that a computational cost of continuing evaluation of candidate graphemes is not offset by a probability of finding a candidate grapheme that produces a comparison value with respect to the probable symbol image that indicates a closer match than an already evaluated candidate grapheme by evaluating the computed completion value and the progress value with respect to additional evaluation criteria.

11. The optical-symbol-recognition system of claim 10 wherein the evaluation criteria further comprises one of:
a cutoff comparison value, with the evaluation of candidate graphemes terminated when the completion value is greater than a first threshold value and the progress value is less than the cutoff comparison value; and
a boundary function, with the evaluation of candidate graphemes terminated when a point described by a coordinate composed of the progress value and the completion value falls below the boundary function.

12. A method employed by an optical-symbol-recognition system having one or more processors, one or more memories, one of more data-storage devices, and computer instructions, stored in one or more of the one or more data-storage devices that, when executed by one or more of the one or more processors, control the optical-symbol-recognition system to carry out the method, the method comprising:
identifying probable symbol images in the text-containing scanned image of the document,
for each identified probable symbol image, identifying and associating with the probable symbol image, in a first processing phase, an ordered set of candidate graphemes, and
for each identified probable symbol image, in a second processing phase, evaluating candidate graphemes associated with the probable symbol image in the first processing phase while monitoring progress towards identifying a matching candidate grapheme for the probable symbol image and terminating evaluation of candidate graphemes when the progress monitoring determines that the probable symbol image does not contain an image of a symbol or when a computational cost of continuing evaluation of candidate graphemes is not offset by a probability of finding a candidate grapheme that produces a comparison value with respect to the probable symbol image that indicates a closer match than an already evaluated candidate grapheme.

13. The method of claim 12 wherein evaluating a candidate grapheme associated with the probable symbol image further comprises:
applying a comparison function to the probable symbol image and the candidate grapheme that produces a comparison value that falls within a range of possible comparison values from a first comparison value to a final comparison value.

14. The method of claim 13
wherein the first comparison value indicates that the probable symbol image exactly matches the candidate grapheme;
wherein the final comparison value indicates that the probable symbol image and the candidate grapheme are unrelated to one another; and
wherein comparison values between the first comparison value and the final comparison value indicate intermediate degrees of matching of the symbol image to the candidate grapheme, with the intermediate levels of matching ordered from best-matching to least matching in the range from the first comparison value to the final comparison value.

15. The method of claim 14 wherein the comparison function produces a comparison value by a comparison method, including one or more of:
computing one or more parameter values and metric values for the probable symbol image and the candidate grapheme and generating the comparison value based on computed differences between the computed values for each parameter and metric;
computing the comparison value as a degree to which the probable symbol image, following rotation and scaling, matches the candidate grapheme;
computing one or more parameter values and metric values for a contour of the probable symbol image and a contour of the candidate grapheme and generating the comparison value based on computed differences between the computed values for each parameter and metric;
computing the comparison value as a degree to which the contour of the probable symbol image, following rotation and scaling, matches the contour of the candidate grapheme;
computing one or more parameter values and metric values for a structure of the probable symbol image and a structure of the candidate grapheme and generating the comparison value based on computed differences between the computed values for each parameter and metric; and
computing the comparison value as a degree to which the structure of the probable symbol image, following rotation and scaling, matches the structure of the candidate grapheme.

16. The method of claim 13 wherein monitoring progress towards identifying a matching candidate grapheme further comprises:
for each successive group of one or more candidate graphemes,
for each candidate grapheme in the group of candidate graphemes, applying the comparison function to the candidate grapheme and the probable symbol image; and
when a comparison value produced from a local best candidate grapheme of the group of candidate graphemes is closer to the first comparison value than a stored best comparison value,
updating the stored best comparison value to store the comparison value produced from the local best candidate grapheme, and
updating a stored indication of the best candidate grapheme to indicate the local best candidate grapheme.

17. The method of claim 16 wherein terminating evaluation of candidate graphemes when the progress monitoring determines that the probable symbol image does not contain an image of a symbol further comprises:
computing a completion value as one of
a percentage of the number of candidate graphemes associated with the probable symbol image already evaluated with respect to the probable symbol image, or
a number of candidate graphemes already evaluated with respect to the probable symbol image;
computing a progress value as one of
the stored best comparison value,
a difference between the value currently stored in the stored best comparison value and a previous value stored in the stored best global comparison value, or
a combination of the stored best comparison value and the difference between the value currently stored in the stored best comparison value and the previous value stored in stored best comparison value; and
evaluating the computed completion value and the progress value with respect to evaluation criteria to determine whether or not to terminate evaluation of candidate graphemes.

18. The method of claim 17 wherein the evaluation criteria further comprises one of:
a cutoff comparison value, with the evaluation of candidate graphemes terminated when the completion value is greater than a first threshold value and the progress value is greater than the cutoff comparison value or when the completion value is greater than a second threshold value and the progress value is equal to or less than the cutoff comparison value; and
first and second boundary functions, with the evaluation of candidate graphemes terminated when a point described by a coordinate composed of the progress value and the completion value falls above the first boundary function or below the second boundary function.

19. Computer instructions, stored within a computer-readable device, that, when executed by one or more processors of an optical-symbol-recognition system having the one or more processors, one or more memories, and one of more data-storage devices, control the optical-symbol-recognition system to carry out a method comprising:
identifying probable symbol images in the text-containing scanned image of the document,
for each identified probable symbol image, identifying and associating with the probable symbol image, in a first processing phase, an ordered set of candidate graphemes, and
for each identified probable symbol image, in a second processing phase, evaluating candidate graphemes associated with the probable symbol image in the first processing phase while monitoring progress towards identifying a matching candidate grapheme for the probable symbol image and terminating evaluation of candidate graphemes when the progress monitoring determines that the probable symbol image does not contain an image of a symbol or when a computational cost of continuing evaluation of candidate graphemes is not offset by a probability of finding a candidate grapheme that produces a comparison value with respect to the probable symbol image that indicates a closer match than an already evaluated candidate grapheme.

20. The computer instructions of claim 19 wherein evaluating a candidate grapheme associated with the probable symbol image further comprises applying a comparison function to the probable symbol image and the candidate grapheme that produces a comparison value that falls within a range of possible comparison values from a first comparison value to a final comparison value;
wherein the first comparison value indicates that the probable symbol image exactly matches the candidate grapheme;
wherein the final comparison value indicates that the probable symbol image and the candidate grapheme are unrelated to one another; and
wherein comparison values between the first comparison value and the final comparison value indicate intermediate degrees of matching of the symbol image to the candidate grapheme, with the intermediate levels of matching ordered from best-matching to least matching in the range from the first comparison value to the final comparison value.
